(19) United States
(12) Patent Application Publication
(10) Pub. No.: US 2009/0182866 A1
(43) Pub. Date: Jul. 16, 2009

(54) Method of setting and managing performance monitoring conditions and computer system using the method

(76) Inventors: Kentaro Watanabe, Yokohama (JP); Yoshimasa Masuoka, Kunitachi (JP)

Correspondence Address: MCDERMOTT WILL & EMERY LLP, 600 13TH STREET, N.W., WASHINGTON, DC, 20005-3096, US

(21) Appl. No.: 12/149,089

(22) Filed: Apr. 25, 2008

(30) Foreign Application Priority Data
Jan. 16, 2008 (JP) 2008-006814

(51) Int. Cl. G06F 15/173

(52) U.S. Cl. 709/224

(57) ABSTRACT

In order to change a policy while alarm-monitoring a production environment, during a production-environment operation, a method of controlling a computer system is provided, in which a policy is temporarily changed, thereby performing setting change. An agent transmits a monitoring result based on a first monitoring condition. A management unit generates a second monitoring condition based on a received change request. The agent transmits a monitoring result based on the second monitoring condition. The management unit holds information for correlating the first and second monitoring conditions with each other. Upon reception of a confirmation request for confirming the second monitoring condition, the management unit specifies the first monitoring condition correlated with the second monitoring condition based on the information. The agent which has received the deletion request stops the transmission of the monitoring result based on the first monitoring condition.

### CLAIM OF PRIORITY

The present application claims priority from Japanese application JP2008-6814 filed on Jan. 16, 2008, the content of which is hereby incorporated by reference into this application.

### BACKGROUND

A technology disclosed herein relates to setting and management of performance monitoring conditions of an information processing system.

In the information processing system, increased loads cause a deterioration in processing performance of an operating system and an application program.

Monitoring methods of the information processing system include, for example, a monitoring monitor method and an alarm monitoring method. The monitoring monitor methods include, for example, a method of obtaining and displaying current performance information of the information processing system in real time to investigate a current status of the information processing system, and a method of investigating past performance information by storing performance information as history information in a storage system. According to the alarm monitoring method, a monitoring policy containing monitoring conditions such as a threshold value for collected performance information and definition of an action executed when the monitoring conditions are satisfied is set and, upon satisfying of the monitoring conditions of the monitoring policy, an action of an event such as lighting of an abnormality patrol lamp, distribution of a mail or execution of a command is issued. Through such performance monitoring, a failure of the information processing system can be detected to set its countermeasures.

To alarm-monitor a monitoring target, a monitoring policy (hereinafter, simply referred to as a policy) containing monitoring conditions and an event issued when the monitoring conditions are satisfied is defined, and the defined policy is correlated with the monitoring target. Thus, the monitoring target can be alarm-monitored. Whether performance information collected for the monitoring target satisfies the monitoring conditions defined in the policy is judged one after another. If a result of the judgment shows that the monitoring conditions are satisfied, the event defined in the policy is issued.

For example, JP 08-316958 A discloses a method of automatically setting a threshold value (in other words, a monitoring condition) to a proper value.

### SUMMARY

An object of this invention is to enable an operator to monitor a production environment based on a policy before a change simultaneously with test work where a system administrator changes the policy to carry out setting review investigation of the policy during a production-environment operation. The system administrator has the authority to change a system configuration or the policy. The operator monitors a monitoring screen of an information processing system, and has a duty to notify, upon detection of a system failure, the system administrator of the failure. For example, the operator always monitors an abnormality patrol lamp that indicates a system failure according to a manual, and communicates lighting of the abnormality patrol lamp to the system administrator by telephone upon noticing the lighting.

Generally, because of problems of the policy itself, when it is found during the production-environment operation that a threshold event being monitored (in other words, event generated when performance information satisfies monitoring conditions) is not generated at proper timing, or when the system configuration to be monitored is changed, setting of the monitoring conditions has to be reviewed while monitoring of a production environment is continued. In the case of the method of dynamically adjusting the monitoring conditions autonomously as disclosed in JP 08-316958 A, validity description of reliability and validity of an adjustment value is generally difficult. Accordingly, for a system required to have reliability, setting of monitoring conditions has to be reviewed manually by trial and error based on system administrator's experience and intuition. A technology for simplifying this trial and error manual work has to be developed.

The following methods are available to change a policy.

The first method is to directly change and investigate a policy for a production environment. However, when this method is used, a great many events which the operator monitoring the production environment does not have to deal with are issued, or conversely no event is issued even when a failure occurs, and thus the operator may overlook the failure.

The second method is to generate a policy for investigation by copying a production-environment policy to be investigated. Contents of the investigation policy are edited by trial and error. When a change is confirmed, the production-environment policy which is a copy source is discarded, and the investigation policy replaces the production-environment policy. As a result, the investigation policy is used as a new production-environment policy. When an investigation policy is generated by copying, an event notification destination is changed from “OPERATOR” to “SYSTEM ADMINISTRATOR”. Then, when a change is confirmed, and the investigation policy replaces the production-environment policy, an event notification is conversely changed from “SYSTEM ADMINISTRATOR” to “OPERATOR”. If this method is used, however, when the production-environment policy is copied to generate an investigation policy, no correlation is set between the production-environment policy of a copy source and the investigation policy of a copy destination. Thus, when a change is confirmed, unless the system administrator has any knowledge of this correlation information, contents of the investigation policy cannot be applied to the production-environment policy.

According to a representative invention disclosed in this application, there is provided a method of controlling a computer system including at least one computer, each of the at least one computer including an interface coupled to a network, a processor coupled to the interface, and a memory coupled to the processor, the computer system including an agent realized by executing a predetermined program by at least one processor, and a management unit realized by executing a predetermined program by at least one processor, the computer system holding a plurality of monitoring conditions used for monitoring a metric value of a resource included in the computer system, the plurality of monitoring conditions including a first monitoring condition, the method comprising: a first step of transmitting, by the agent, a monitoring result of the metric value based on the first monitoring condition; a second step of generating, by the management unit, upon reception of a first change request containing information for identifying the first monitoring condition and information for specifying contents to be changed with respect to the first monitoring condition, a second monitoring condition which is one of the plurality of monitoring conditions based on the contents to be changed contained in the first change request; a third step of transmitting, by the management unit, an addition request for adding the second monitoring condition to the agent; a fourth step of transmitting, by the agent which has received the addition request, a monitoring result of the metric value based on the second monitoring condition; a fifth step of holding, by the management unit, first information for correlating the first monitoring condition and the second monitoring condition with each other; a sixth step of specifying, by the management unit, upon reception of a confirmation request for confirming the second monitoring condition, the first monitoring condition correlated with the second monitoring condition based on the first information; a seventh step of transmitting, by the management unit, a deletion request for deleting the first monitoring condition to the agent; and an eighth step of stopping, by the agent which has received the deletion request, the transmitting of the monitoring result of the metric value based on the first monitoring condition.

According to an embodiment of this invention, only by issuing a policy setting change request and a change confirmation request without being aware of internal processing of the system, the system administrator can investigate defined contents of the policy to reflect a result of the investigation in the original policy.

### BRIEF DESCRIPTION OF THE DRAWINGS

FIG. 1 is a functional block diagram illustrating a configuration of an information processing system according to an embodiment of this invention.

FIG. 2 is a functional block diagram illustrating a detailed configuration of a performance monitoring agent and a performance monitoring manager included in the information processing system according to the embodiment of this invention.

FIG. 3 illustrates a bind table according to the embodiment of this invention.

FIG. 4 illustrates a policy change table according to the embodiment of this invention.

FIG. 5 illustrates a policy management table according to the embodiment of this invention.

FIG. 6 is a block diagram illustrating a hardware configuration of a computer which constitutes the information processing system according to the embodiment of this invention.

FIG. 7 illustrates another policy management table according to the embodiment of this invention.

FIG. 8 illustrates a collected record table according to the embodiment of this invention.

FIG. 9 is a sequential diagram illustrating an overall process of the information processing system according to the embodiment of this invention.

FIG. 10 is a flowchart illustrating a process executed when a system administrator issues a policy change request message according to the embodiment of this invention.

FIG. 11 is a flowchart illustrating a process executed when the system administrator issues a policy change confirmation message according to the embodiment of this invention.

FIG. 12 is a flowchart illustrating a process executed when a request for discarding a policy change is issued according to the embodiment of this invention.

FIGS. 13A and 13B are flowcharts illustrating a process executed to reflect a policy change in a plurality of performance monitoring agents according to the embodiment of this invention.

FIGS. 14A and 14B are flowcharts illustrating a process executed for generating another investigation policy from an investigation policy according to the embodiment of this invention.

FIG. 15 illustrates an example of a monitoring screen referred to by the system administrator according to the embodiment of this invention.

FIG. 16 illustrates an example of a monitoring screen displayed to adjust a threshold value of a conditional expression set in a policy according to the embodiment of this invention.

FIG. 17 illustrates a policy group table according to the embodiment of this invention.

FIG. 18 illustrates a policy group change table according to the embodiment of this invention.

FIG. 19A is a flowchart illustrating a process executed when a policy change request message is issued for each policy group according to the embodiment of this invention.

FIG. 19B is a flowchart illustrating a process executed when a policy change confirmation message of each policy group is issued according to the embodiment of this invention.

### DETAILED DESCRIPTION OF THE PREFERRED EMBODIMENT

The preferred embodiment of an information processing system of this invention will be described below in detail referring to the drawings.

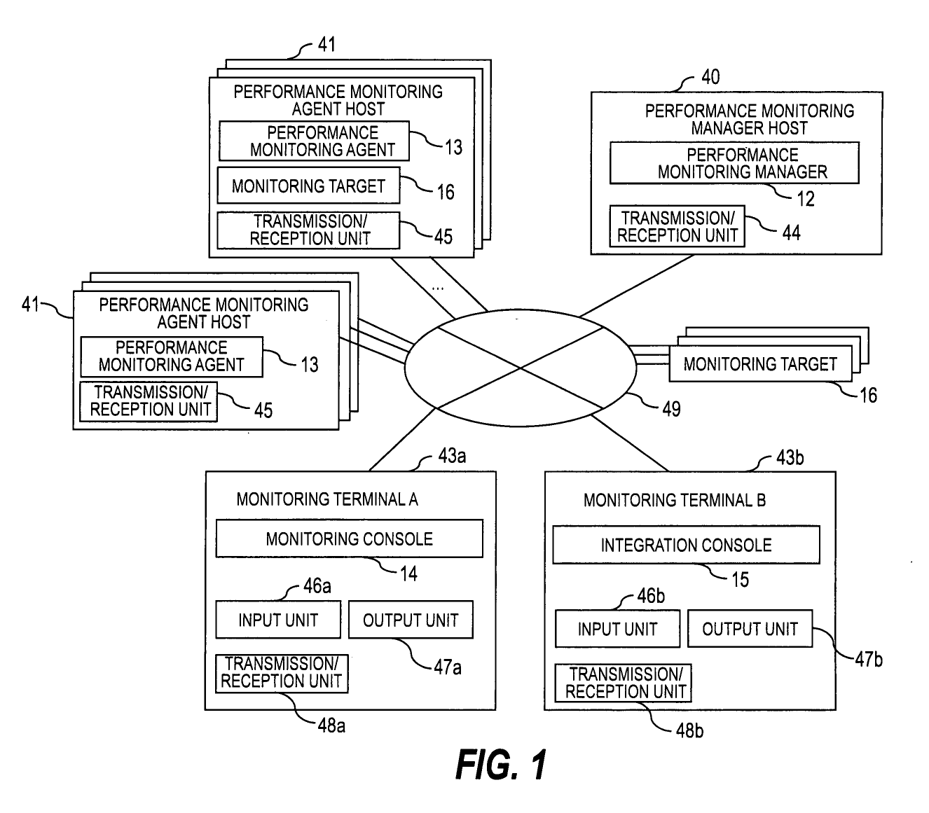

FIG. 1 is a functional block diagram illustrating a configuration of an information processing system according to an embodiment of this invention.

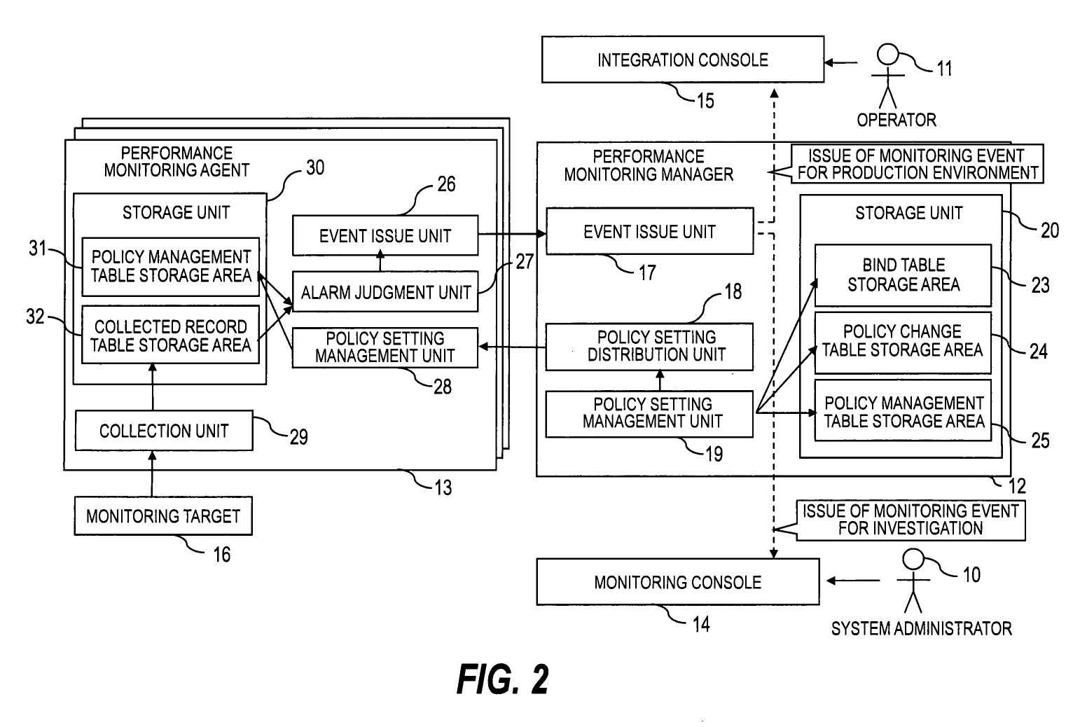

FIG. 2 is a functional block diagram illustrating a detailed configuration of a performance monitoring agent and a performance monitoring manager included in the information processing system according to the embodiment of this invention.

The information processing system according to the embodiment of this invention is a computer system which includes a performance monitoring manager host 40, a performance monitoring agent host 41, and monitoring terminals A 43a and B 43b.

The performance monitoring manager host 40, the performance monitoring agent host 41, the monitoring terminals A 43a and B 43b, and a monitoring target 16 are intercoupled via a network 49.

The monitoring target 16 is a resource of the information processing system whose performance is monitored by the performance monitoring agent 13. The monitoring target 16 may be a resource realized on a computer, such as computer hardware, an operating system (OS), middleware, a software application, a hypervisor of a server virtualized environment, firmware, or a database management system (DBMS), or a device such as a router, a switching hub, a repeater hub, or a fire wall directly coupled to a network.

The performance monitoring manager host 40 includes a performance monitoring manager 12 and a transmission/reception unit 44.

The performance monitoring manager 12 is middleware for managing a status of the performance monitoring agent 13 or relaying an event issued from the performance monitoring agent 13 to an integration console 15 or a monitoring console 14.

The performance monitoring manager 12 includes an event issue unit 17, a policy setting distribution unit 18, a policy setting management unit 19, and a storage unit 20.

The event issue unit 17 receives an event issued from an event issue unit 26 described below, and notifies (transmits) the event to the integration console 15 or the monitoring console 14 based on notification destination information of the event.

The policy setting distribution unit 18 receives information for specifying a policy change and information for specifying the performance monitoring agent 13 to change a policy from the policy setting management unit 19 described below, and notifies, via the transmission/reception unit 44, the pieces of information to a policy setting management unit 28 of the specified performance monitoring agent 13 through the network 49.

The policy setting management unit 19 centrally manages policies applied to resource monitoring of the performance monitoring agent 13 managed by the performance monitoring manager 12. The policy setting management unit 19 receives pieces of predetermined information from the monitoring terminals A 43a and B 43b via the transmission/reception unit 44, obtains necessary information from the storage unit 20 described below, and writes necessary information in the storage unit 20. When necessary information is written in the storage unit 20, the policy setting management unit 19 notifies the policy setting distribution unit 18 of predetermined information regarding writing in the storage unit 20. Then, the policy setting management unit 19 notifies the monitoring terminals A 43a and B 43b via the transmission/reception unit 44 of a processing result.

Specifically, upon reception of a policy change request message, a policy change confirmation message or a policy change discard message from the monitoring terminal A 43a via the transmission/reception unit 44, the policy setting management unit 19 executes processing according to the received message.

The policy change request message contains information for specifying an agent name concerning a change, a name of a policy to be changed, or changing contents of the policy.

The policy setting management unit 19 that has received the policy change request message duplicates a policy corresponding to the specified policy name, and applies changed contents of the specified policy to contents of the duplicated policy to generate a new policy.

The policy setting management unit 19 rewrites an alarm notification destination specified by the new policy. Further, the policy setting management unit 19 correlates policies before and after the changed contents are applied (in other words, duplication source policy and new policy duplicated to change its contents) with each other.

Then, the policy setting management unit 19 instructs the policy setting distribution unit 18 to notify the performance monitoring agent 13 corresponding to the specified agent name of information of the newly generated policy. The policy setting management unit 19 returns a processing result to the monitoring terminal A 43a via the transmission/reception unit 44.

The policy change confirmation message is for requesting an investigation policy generated according to the policy change request message to be confirmed as a new production-environment policy. The policy change confirmation message contains information for specifying a name of a policy to be confirmed as a new production-environment policy and information for specifying an agent name of the performance monitoring agent 13 to which the policy is applied.

The policy setting management unit 19 that has received the policy change confirmation message refers to a policy corresponding to the specified policy name, discards a policy (in other words, policy which has been a production-environment policy) correlated with the policy referred to, and rewrites contents of the policy referred to.

The policy setting management unit 19 instructs the policy setting distribution unit 18 to notify the performance monitoring agent 13 corresponding to the specified agent name of contents of the discarding processing and contents of the rewriting processing. The policy setting management unit 19 returns the processing results to the monitoring terminal A 43a via the transmission/reception unit 44. The process of rewriting the contents of the policy is, for example, a process of rewriting an alarm notification destination.

The policy change discard message is for requesting discarding of the investigation policy generated according to the policy change request message without confirming it as a new production-environment policy. The policy change discard message contains information for specifying a name of a policy to be discarded and information for specifying an agent name of the performance monitoring agent 13 to which the policy is applied.

The policy setting management unit 19 that has received the policy change discard message refers to a policy (here, described as a second policy) corresponding to the specified policy name, and a first policy correlated with the second policy before transmission of the policy change request message to discard the second policy specified by the policy change discard message. Further, the policy setting management unit 19 instructs the policy setting distribution unit 18 to notify the performance monitoring agent 13 corresponding to the specified performance monitoring agent of discard processing contents of the second policy. The policy setting management unit 19 specifies contents of the first policy to return the discard processing result to the monitoring terminal A 43a via the transmission/reception unit 44.

The storage unit 20 includes a bind table storage area 23, a policy change table storage area 24, and a policy management table storage area 25.

The bind table storage area 23 stores information for correlating policy information managed in the policy management table storage area 25 with the performance monitoring agent 13 performing monitoring by using the policy (in other words, the performance monitoring agent 13 to which the policy is applied). Presence of correlation information in the bind table storage area 23 indicates that the performance monitoring agent 13 contained in the correlation information is performing monitoring based on a policy contained in the correlation information. Conversely, nonstorage of information for correlating a certain performance monitoring agent 13 with a certain policy in the bind table storage area 23 indicates that the performance monitoring agent 13 is not performing alarm monitoring by using the policy.

For example, a bind table 230 is stored in the bind table storage area 23.

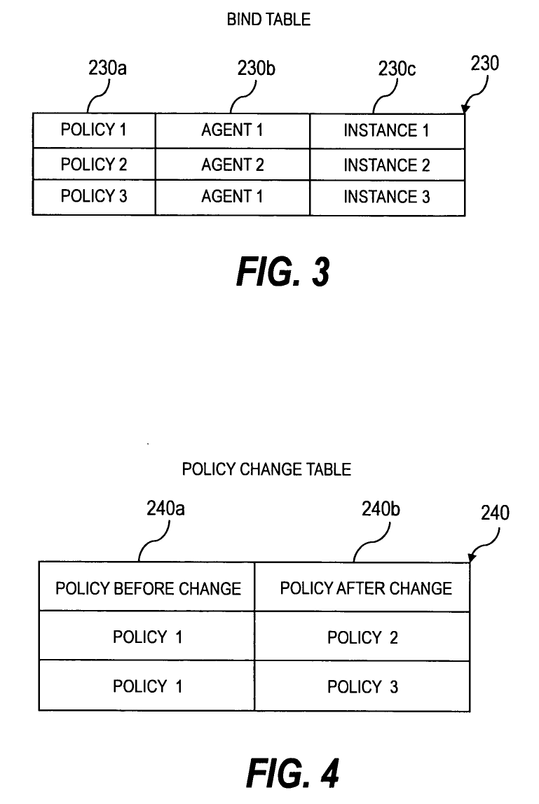

FIG. 3 illustrates the bind table 230 according to the embodiment of this invention.

As shown in FIG. 3, the bind table 230 includes a policy ID section 230a, an agent section 230b, and an instance section 230c.

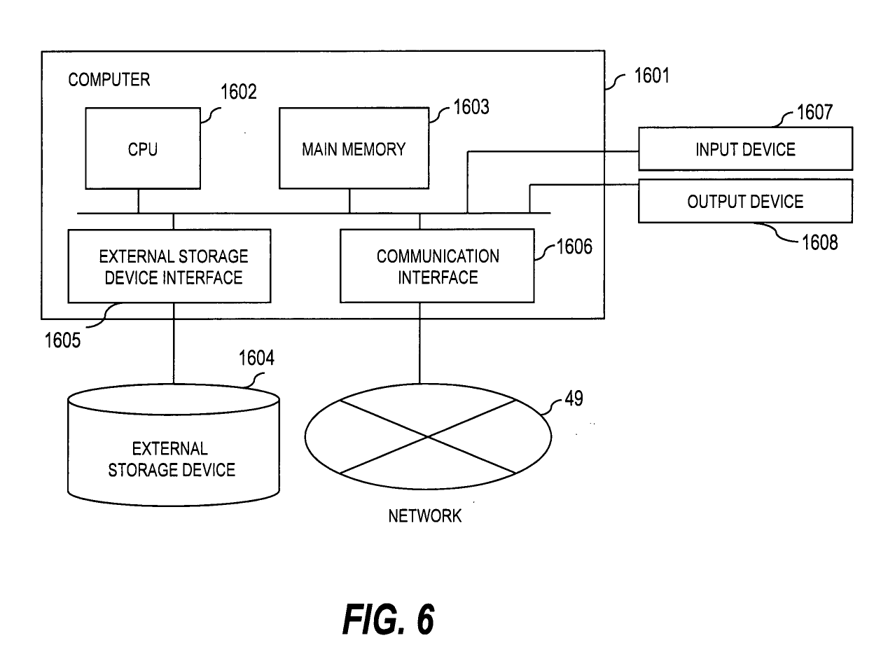

In the policy ID section 230a, identification information for uniquely identifying a policy is stored. This identification information corresponds to information stored in a policy ID section 250 a of the policy management table area 25 described below referring to FIG. 5. In other words, according to this embodiment, in the policy ID section 230a, a name of a policy (e.g., “POLICY 1”) registered in the policy ID section 250a of a policy management table 250 stored in the policy management table storage area 25 is stored.

In the agent section 230b, identification information for uniquely identifying a performance monitoring agent 13 is stored. As identification information, for example, a uniform resource identifier (URI) of the performance monitoring agent 13 may be stored. According to this embodiment, a name of an agent is stored in the agent section 230b.

In the instance section 230c, information for uniquely identifying an instance managed by an agent is stored. When the performance monitoring agent 13 monitors a plurality of instances, a value is stored in this section. On the other hand, when the performance monitoring agent 13 monitors only one instance, no instance section 230c may be set in the bind table 230, or an instance section 230c is undefined, and for example, “N/A” may be stored. The instance is, for example, a database instance when a monitoring target is a database.

In the policy change table storage area 24, correlation information for correlating policies managed in the policy management table storage area 25 with each other is stored. For example, when a production-environment policy is copied to generate an investigation policy, information for correlating the production-environment policy with the investigation policy generated by copying the policy is stored.

For example, a policy change table 240 is stored in the policy change table storage area 24.

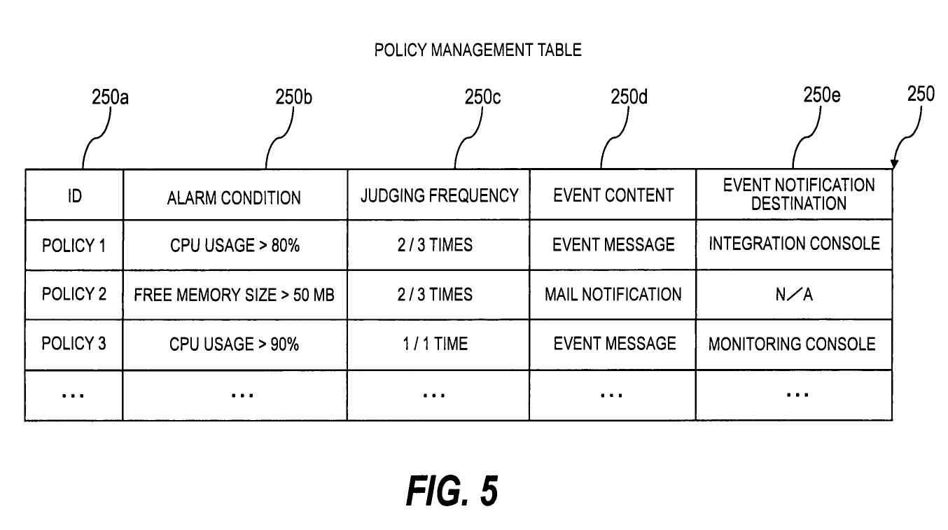

FIG. 4 illustrates the policy change table 240 according to the embodiment of this invention.

As shown in FIG. 4, the policy change table 240 includes a before-change policy ID section 240a and an after-change policy ID section 240b. In each record of the policy change table 240 (each line shown in FIG. 4), changing of a policy corresponding to contents stored in the before-change policy ID section 240a to a policy corresponding to contents stored in the after-change policy ID section 240b is stored.

In each of the before-change policy ID section 240a and the after-change policy ID section 240b, identification information for uniquely identifying a policy is stored. The identification information corresponds to contents stored in the policy ID section 250a of the policy management table 250 described below. According to this embodiment, policy names (e.g., “POLICY 1” and “POLICY 2”) are stored in the before-change policy ID section 240a and the after-change policy ID section 240b.

In an example of FIG. 4, “POLICY 1” and “POLICY 2” are respectively stored in the before-change policy ID section 240a and the after-change policy ID section 240b of a first record of the policy change table 240. This indicates that a policy (e.g., first policy) identified by “POLICY 1” is correlated with a policy (e.g., second policy) identified by “POLICY 2”. Correlation between the first and second policies may mean, for example, that the first policy is a production-environment policy and the second policy is an investigation policy derived from the first policy. A relation between the production-environment policy and the investigation policy will be described below.

In the policy management table storage area 25, policy definition information regarding policies centrally managed by the performance monitoring manager 12 is stored.

For example, the policy management table 250 is stored in the policy management table storage area 25.

FIG. 5 illustrates the policy management table 250 according to the embodiment of this invention.

In the policy management table 250, policies applied to performance monitoring of metric values of resources carried out by the performance monitoring agent 13 of this embodiment are stored.

As shown in FIG. 5, the policy management table 250 includes a policy ID section 250a, an alarm condition section 250b, a judging frequency section 250c, an event content section 250d, and an event notification destination section 250e.

In the policy ID section 250a, identification information for uniquely identifying each policy managed by the policy management table 250 is stored. According to this embodiment, a policy name is registered as identification information.

In the alarm condition section 250b, a policy monitoring condition judgment expression, in other words, a judgment expression used for judging whether to issue an event in monitoring based on the policy, is stored. Specifically, in the alarm condition section 250b, a performance monitoring metric, a threshold value regarding the performance monitoring metric, and a conditional expression indicating a relation between the performance monitoring metric and the threshold value are stored. The performance monitoring metric is compared with the threshold value according to the conditional expression. Based on a result of the comparison, an event defined in the event content section 250d described below is issued.

For example, when “CPU USAGE”, “80%” and “>” are respectively defined as a performance monitoring metric, a threshold value, and a conditional expression, a judgment expression is “CPU USAGE>80%”. This defines an alarm condition that an event is issued when a CPU usage of the monitoring target 16 exceeds 80%.

The performance monitoring metric is general performance information managed by an OS or a DBMS. For example, in addition to “CPU USAGE”, “MEMORY USAGE”, “DISK CAPACITY USAGE”, “NUMBER OF PAGING ISSUES PER UNIT TIME”, and “NUMBER OF I/O REQUESTS PER UNIT TIME” correspond to performance monitoring metrics. Alternatively, in place of the performance information, a program name or sampling time may be specified as a performance monitoring metric.

The conditional expression may be a logical expression including “=”, “<”, “> =” and “< =”, or a judgment expression which uses regular representation such as complete or partial matching of a character string.

For alarm conditions, a complex condition can be defined. For example, a conditional expression such as “(CPU USAGE>80%) AND (2007/08/27 10:00:00<SAMPLING TIME<2007/08/27 12:00:00)” may be defined. In this example, when a CPU usage exceeding 80% is detected during a period from 10:00 to 12:00 of Aug. 27, 2007, an event is issued.

In the judging frequency section 250c, a frequency of performing monitoring condition judgment is stored. For example, a collection unit 29 of the performance monitoring agent 13 may, in the case of obtaining performance information from the monitoring target 16 by sampling of a fixed interval, continuously perform sampling three times to judge a threshold value condition, and issue an alarm when a threshold value is exceeded twice or more. In this case, in the judging frequency section 250c, information of twice out of three (“2/3 times)” is defined. By defining the judging frequency, issue of an alarm requiring no dealing caused by a temporary load increase can be prevented.

In the event content section 250d, contents of an event issued when the conditions defined in the alarm condition section 250b and the judging frequency section 250c are stored. This event may include transmission or displaying of a result of comparing the metrical value with the threshold value based on the monitoring conditions defined in the alarm condition section 250b. For example, as event contents, transmission of an event message, mail transmission, lighting of an abnormal or warning patrol lamp, execution of a command, or log outputting may be specified. The patrol lamp may be, for example, an icon displayed in the monitoring console 14 or the integration console 15 described below, where displaying changes between normal time and abnormal or warning time.

In the event notification destination section 250e, an event notification destination of an alarm is stored. As a notification destination, for example, a URI of the monitoring console 14, a URI of the integration console 15, a URI of an event execution engine of a certain host, or a mail address of a mail notification destination is registered. According to this embodiment, the URI of the integration console and the URI of the monitoring console are stored.

As described above, according to this embodiment, the policy management table 250 stored in the policy management table storage area 25 and the bind table 230 stored in the bind table storage area 23 are present. In the policy management table 250, definition information of a policy is stored whichever performance monitoring agent 13 the policy is applied to. In the bind table 230, correlation information between the performance monitoring agent 13 and a policy defined in the policy management table 250 is stored.

Accordingly, the policy defined in the policy management table 250 can be used again. For example, a policy common among a plurality of performance monitoring agents 13 is defined as one policy in the policy management table 250, and the defined policy can be applied to each performance monitoring agent 13.

It should be noted that the configuration of the storage area of this embodiment is in no way limitative. The bind table storage area 23 and the policy management table storage area 25 may be realized as one storage area. For example, the bind table 230 and the policy management table 250 may be replaced with one table which includes a policy ID section, an alarm condition section, a judging frequency section, an event content section, an event notification destination section, and a performance monitoring agent section, and an instance section. Even with this configuration, the same effects as those of this embodiment can be provided.

The transmission/reception unit 44 is a device for transmitting/receiving information via the network 49.

Information processing of the components of the performance monitoring manager host 40 thus configured is specifically realized by hardware resources.

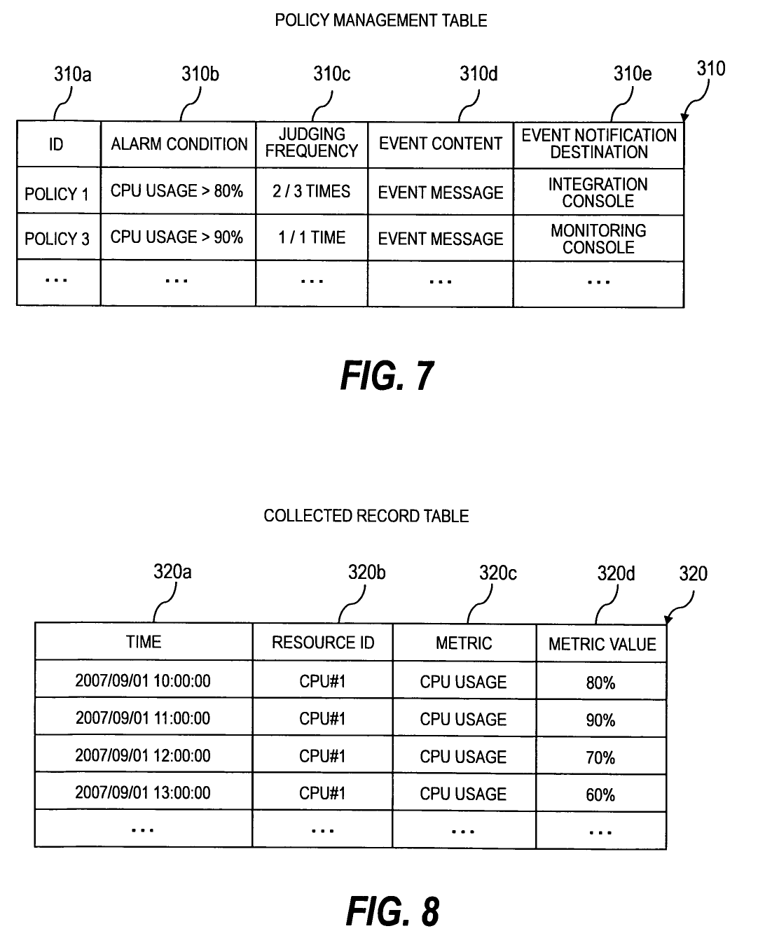

FIG. 6 is a block diagram illustrating a hardware configuration of a computer which constitutes the information processing system according to the embodiment of this invention.

The performance monitoring manager host 40 can be realized by a computer 1601 shown in FIG. 6. The computer 1601 includes a CPU 1602, a main memory 1603, an external storage device 1604, an external storage interface 1605 for connection with the external storage device 1604, and a communication interface 1606 for connection with the network 49. The computer 1601 may further include an input device 1607 and an output device 1608. The input device 1607 is, for example, a mouse or a keyboard. The output device 1608 is, for example, a monitor (image display device).

The transmission/reception unit 44 can be realized by the communication interface 1606 such as a network interface card (NIC). The storage unit 20 can be realized by the external storage device. The external storage device 1604 is, for example, a hard disk device or another type of a storage device.

The event issue unit 17, the policy setting distribution unit 18, and the policy setting management unit 19 can be realized by copying a predetermined program stored in the external storage device 1604 to the main memory 1603, and executing the program via the CPU 1602. The main memory 1603 is, for example, a semiconductor memory or another type of a storage device.

Referring again to FIGS. 1 and 2, the performance monitoring agent host 41 will be described.

The performance monitoring agent host 41 includes a performance monitoring agent 13, a monitoring target 16, and a transmission/reception unit 45.

The performance monitoring agent 13 is middleware for monitoring performance information of the monitoring target 16. For example, the performance monitoring agent 13 periodically collects pieces of performance information output from the monitoring target 16, stores the collected pieces of performance information, returns the stored performance information according to a request, judges the collected pieces of performance information based on monitoring conditions set for a policy, and issues an event set in the policy when the monitoring conditions are satisfied.

The pieces of performance information collected by the performance monitoring agent are those supplied from the monitoring target 16. For example, performance information is a CPU usage output from the operating system, the number of processed I/O's per unit time, service response time of a web server or the like, which is measured by an agent for executing a service user's operation in a pseudo manner, the number of processed accesses to the DB, the number of batch processes, or a resource allocation amount for a virtual server at certain time. This performance information corresponds to metric information of an alarm condition section 310b of a policy management table 310.

The performance monitoring agent 13 is managed by the performance monitoring manager 12. The performance monitoring manager 12 manages one or more performance monitoring agents 13.

The performance monitoring agent 13 includes an event issue unit 26, an alarm judgment unit 27, a policy setting management unit 28, a collection unit 29, and a storage unit 30.

The event issue unit 26 issues an event defined in a policy based on a notification from the alarm judgment unit 27 described below. For example, upon notification of an event content of notifying the monitoring console 14 of an event message from the alarm judgment unit 27, the event issue unit 26 notifies the event issue unit 17 of the performance monitoring manager of the event message.

The alarm judgment unit 27 obtains performance information registered in a collected record table 320 described below and conditions of alarm definition registered in the policy management table 310 described below, judges whether the performance information satisfies the conditions of the alarm definition, and notifies the event issue unit 26 of an event content contained in the alarm definition to ask for issue of an event of the notified content.

Specifically, for example, the alarm judgment unit 27 reads the policy management table 310 from a policy management table storage area 31, and the collected record table 320 from the collected record table storage area 32. The alarm judgment unit 27 sequentially reads lines from the policy management table 310 to repeat the following alarm judgment operation.

The alarm judgment unit 27 refers to the number of judging times stored in a judging frequency section 310c of the read line of the policy management table 310. The alarm judgment unit 27 reads, among the lines registered in the collected record table 320, continuous lines of the number of judging times sequentially from a latest value of a time section 320a. For example, when a value of the judging frequency section 310c is “2/3 times” (in other words, twice out of three times), three lines are read.

Then, for each line read from the collected record table 320, the alarm judgment unit 27 judges whether values of a metric section 320c and a metric value section 320d match an alarm condition section 310b of the policy management table 310. When the number of matched times is equal to or more than that stored in the judging frequency section 310c of the policy management table 310, the alarm judgment unit 27 judges that alarm conditions defined in the policy management table 310 have been satisfied. The number of matched times is “two” when a value of the judging frequency section 310c is “2/3 times”. When the alarm conditions are satisfied, the alarm judgment unit 27 instructs the event issue unit 26 to notify a notification destination stored in an event notification destination section 310e of an alarm of contents stored in an event content section 310d.

The policy setting management unit 28 manages a policy used when the performance monitoring agent 13 alarm-monitors the monitoring target 16. Upon notification of changed contents of a policy from the policy setting distribution unit 18, the policy setting management unit 28 changes contents of the policy management table 310 stored in the policy management table storage area 31 according to the notified contents.

The collection unit 29 collects pieces of performance information from the monitoring target 16, and registers the collected pieces of performance information in the collected record table 320 described below.

The storage unit 30 includes a policy management table storage area 31 and a collected record table storage area 32.

For example, the policy management table 310 is stored in the policy management table storage area 31.

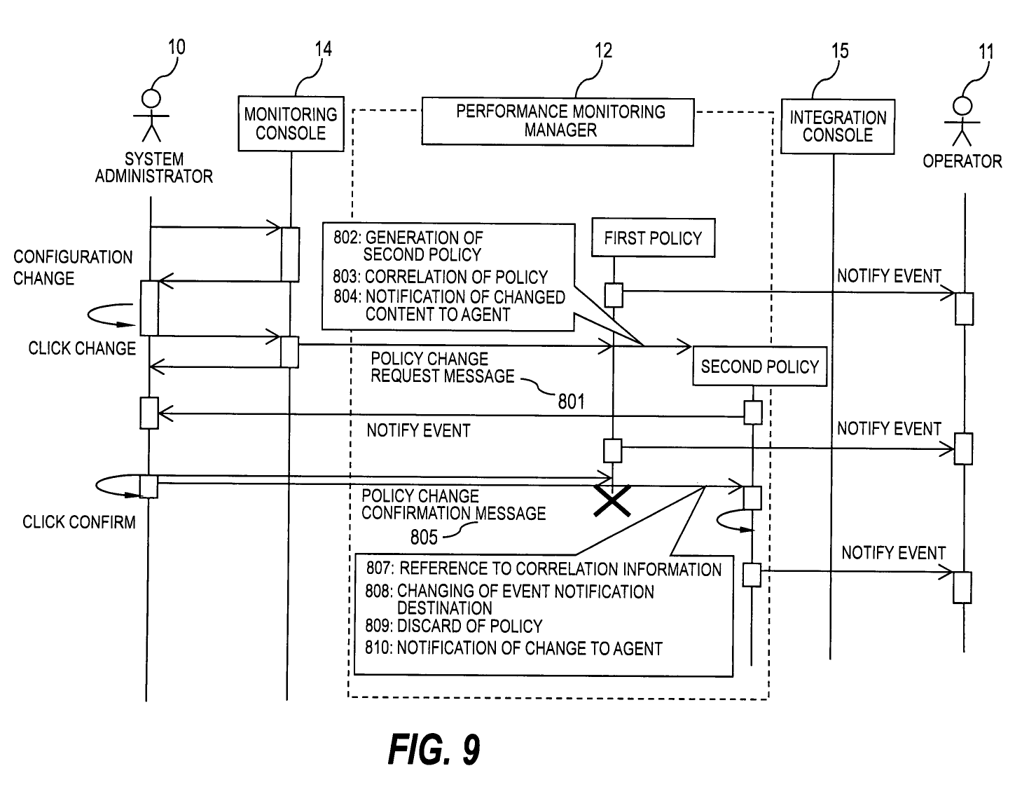

FIG. 7 illustrates the policy management table 310 according to the embodiment of this invention.

The policy management table 310 includes a policy ID section 310a, an alarm condition section 310b, a judging frequency section 310c, an event content section 310d, and an event notification destination section 310e. These sections are similar to the policy ID section 250a, the alarm condition section 250b, the judging frequency section 250c, the event content section 250d, and the event notification destination section 250e of the policy management table 250, and thus description thereof will be omitted.

The policy management table 250 shown in FIG. 5 is stored by the performance monitoring manager 12. This policy management table 250 includes setting information of all the policies set in the information processing system shown in FIG. 1. The set policies may include not only a policy applied to a certain performance monitoring agent 13 but also a policy not applied to any performance monitoring agent 13 (e.g., policy likely to be applied). On the other hand, the policy management table 310 shown in FIG. 7 is stored by each performance monitoring agent 13. This policy management table 310 includes only setting information of a policy applied to the performance agent 13 which stores the table.

For example, as shown in FIG. 3, when two polices identified by “POLICY 1” and “POLICY 2” are applied to the performance monitoring agent 13 identified by “AGENT 1”, in the policy management table 310, among pieces of information stored in the policy management table 250, information regarding the two policies identified by “POLICY 1” and “POLICY 2” is stored.

As described below, upon changing of the contents of the policy management table 250, the changed contents are notified to the performance monitoring agent 13. The performance monitoring agent 13 reflects the change in the policy management table 310 based on the notification.

Only one policy may be applied to each performance monitoring agent 13. However, as shown in FIG. 7, a plurality of policies may be applied. The performance monitoring agent 13 to which the plurality of policies are applied monitors the monitoring target 16 according to each policy to issue an event.

In the collected record table storage area 32, the pieces of performance information collected from the monitoring target 16 by the collection unit 29 are stored.

For example, in the collected record table storage area 32, the collected record table 320 is stored.

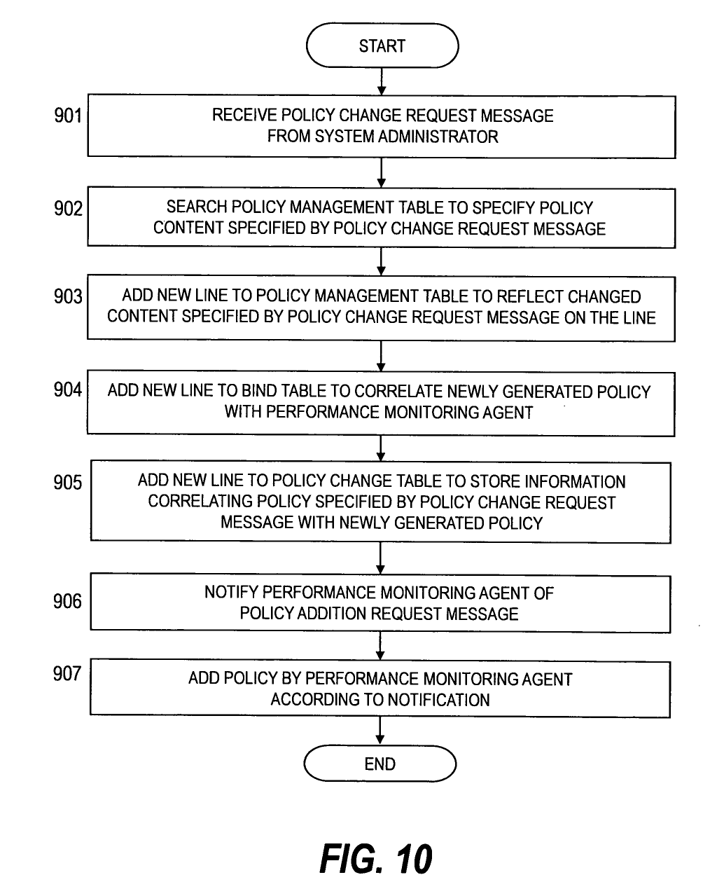

FIG. 8 illustrates the collected record table 320 according to the embodiment of this invention.

As shown, the collected record table 320 includes a time section 320a, a resource ID section 320b, a metric section 320c, and a metric value section 320d.

In the metric value section 320d, metric values collected for performance monitoring are stored.

In the metric section 320c, information for specifying a metric stored in the metric value section 320d is stored. For example, a metric name is stored.

In the resource ID section 320b, information for identifying resources for which the metric values stored in the metric value section 320d are obtained is stored.

In the time section 320a, time of obtaining the metric values stored in the metric value section 320d is stored.

For example, a head line of the collected record table 320 shown in FIG. 8 indicates acquisition of a CPU usage “80%” as a metric value from a resource identified by “CPU #1” at 10:00:00 of Sep. 1, 2007.

The transmission/reception unit 45 transmits/receives information via the network 49.

Information processing of the components of the performance monitoring agent host 41 thus configured can be specifically realized by hardware resources. The performance monitoring agent host 41 can be realized by the computer 1601 as shown in FIG. 6. The configuration of the computer 1601 has been described referring to FIG. 6, and thus description thereof will be omitted.

The transmission/reception unit 45 can be realized by a communication interface 1606 such as a NIC. The storage unit 30 can be realized by an external storage device 1604. The event issue unit 26, the alarm judgment unit 27, the policy setting management unit 28, and the collection unit 29 can be realized by copying a predetermined program stored in the external storage device 1604 to the main memory 1603 and executing the program via the CPU 1602.

The information processing system of this embodiment shown in FIG. 1 includes a plurality of performance monitoring agent hosts 41 and a plurality of monitoring targets 16. Some of the performance monitoring agent hosts 41 include monitoring targets 16. For example, when the monitoring target 16 is the CPU 1602 or the main memory 1603 of the computer 1601, the computer 1601 which includes the CPU 1602 or the main memory 1603 itself may operate as a performance monitoring agent host 41. In this case, the monitoring target 16 is included in the performance monitoring agent host 41. On the other hand, for example, when the monitoring target 16 is a port of a device constituting the network 49 or the like, the performance monitoring agent host 41 may be realized by the computer 1601 coupled to the monitoring target 16 via the network 49.

The system administrator 10 has the authority to change the system configuration or policy contents. Generally, the system administrator 10 has great knowledge about the information processing system to be monitored. When hardware is added or the system configuration is changed in the information processing system to be monitored, the system administrator 10 reviews policy setting.

The operator 11 has the authority to monitor the integration console 15 of the information processing system, and to notify the system administrator upon lighting of the abnormality patrol lamp. Generally, the operator 11 has no great knowledge about the information processing system to be monitored, and works according to an operation manual distributed beforehand. For example, when the abnormality patrol lamp is displayed in a monitoring result of the integration console 15 of the information processing system, the operator 11 calls the system administrator to notify the system administrator 10 of the displaying of the abnormality patrol lamp.

The system administrator 10 and the operator 11 each represent a role. Accordingly, the system administrator 10 and the operator 11 may be the same person or different persons. As the roles of the system administrator 10 and the operator 11 are different from each other, a person having the authority of a system administrator and a person having the authority of an operator are generally different. However, this embodiment is not limited to such division of roles.

For example, when the monitoring console 14 and the integration console 15 are realized by the same monitoring screen program, a log-in ID and information indicating the authority of the system administrator 10 or the operator 11 may be correlated with each other beforehand. In this case, based on the log-in ID entered at the time of logging-in to the monitoring screen, which of the system administrator 10 and the operator 11 a person who has logged-in is can be judged. Based on a result of the judgment, one of monitoring screen contents of the system administrator 10 and the operator 11 can be displayed on the monitoring screen after the logging-in.

The monitoring terminal A 43a performs policy management such as alarm monitoring of a monitoring target or definition changing of a policy. The monitoring terminal A 43a receives predetermined information entered from the system administrator 10 via an input unit 46a described below, and generates a necessary message from the predetermined information to transmit the message to the performance monitoring manager 12 via a transmission/reception unit 48a described below. Further, upon reception of the predetermined information from the performance monitoring manager 12 via the transmission/reception unit 48a, the monitoring terminal A 43a processes necessary information from the predetermined information to output the necessary information to the system manger 10 via an output unit 47a described below.

The necessary message is, specifically, for example, an alarm monitoring request message, a policy generation request message, a policy change request message, a policy change confirmation message, or a policy bind request message.

The alarm monitoring request message contains pieces of information for specifying performance monitoring agent identification information and policy identification information. Each of the policy generation request message and the policy change request message contains information for specifying alarm definition contents. The information for specifying the alarm definition contents contains, for example, policy identification information, an alarm conditional expression, an event content, an event notification destination, and a judging frequency. The policy change confirmation message contains pieces of information for specifying performance monitoring agent identification information and policy identification information. The policy bind request message contains pieces of information for specifying performance monitoring agent identification information and policy identification information.

The monitoring terminal A 43a includes the input unit 46a, the output unit 47a, the transmission/reception unit 48a, and the monitoring console 14.

The input unit 46a is an input device for receiving an input from the system administrator 10.

The output unit 47a is an output device for notifying the system administrator 10 of predetermined information.

The transmission/reception unit 48a is a device for transmitting/receiving information via the network 49.

The monitoring console 14 is a console screen for performance monitoring. The monitoring console 14 may include, for example, a management screen of a policy managed by the information processing system of this embodiment, a monitoring screen for displaying an alarm-monitoring result, a monitoring screen for displaying collected pieces of performance information by a table or a graph in real time, or a monitoring screen for time-sequentially displaying history information of the collected pieces of performance information by a table or a graph.

The system administrator 10 can execute, by using the policy management screen, for example, defining of a new policy, changing of a policy by editing, and applying of a policy to the performance monitoring agent.

The system manger 10 can see a monitoring result based on a policy applied to each performance monitoring agent by referring to the policy monitoring screen. The policy monitoring result is, for example, lighting of the abnormality patrol lamp or the warming lamp which indicates the occurrence of a failure in the performance monitoring agent, or displaying of an abnormality event message or a warming event message.

The system administrator 10 reviews setting of a policy targeting the monitoring target 16 for monitoring by using the monitoring console 14. Any type of display format of the monitoring console 14 may be employed. In other words, a screen displayed by the monitoring console 14 may be a GUI display screen or a CUI display screen.

Information processing of the components of the monitoring terminal A 43a as described above can specifically be realized by hardware resources. Specifically, the monitoring terminal A 43a can be realized by the computer 1601. The configuration of the computer 1601 has been described referring to FIG. 6, and thus description thereof will be omitted.

The input unit 46a can be realized by the input device 1607 such as a mouse or a keyboard. The output unit 47a can be realized by the output unit 1608 such as a monitor. The transmission/reception unit 48a can be realized by the communication interface 1606 such as a NIC. The monitoring console 14 can be realized by loading a predetermined program stored in the external storage device 1604 on the main memory 1603 and executing the program via the CPU 1602.

The monitoring terminal B 43b performs alarm-monitoring of a monitoring target. The monitoring terminal B 43b receives predetermined information entered from the operator 11 via the input unit 46b described below, and generates a necessary message from the predetermined information to transmit the message to the performance monitoring manager 12 via the transmission/reception unit 48b described below. Further, upon reception of the predetermined information from the performance monitoring manager 12 via the transmission/reception unit 48b, the monitoring terminal B 43b processes the predetermined information to output necessary information to the operator 11 via the output unit 47b described below.

The predetermined information is specifically a policy change request message, a policy change confirmation message, or a policy change discard message which specifies performance monitoring agent information or policy information.

The necessary information is specifically a processing result of a policy change request message, a policy change confirmation message or a policy change discard message.

The monitoring terminal B 43b includes the integration console 15, the input unit 46b, the output unit 47b, and the transmission/reception unit 48b.

The integration console 15 is a console screen for operation management, which can be used for event monitoring, alarm monitoring, and the like. The integration console 15 may include, for example, a monitoring screen for displaying events issued from an agent program for managing various operations of the performance monitoring agent 13 and the like to centrally monitor the events, or a monitoring screen for lighting the abnormality patrol lamp when a threshold value set in each metric is exceeded.

The operator 11 performs performance monitoring of a production environment which targets the monitoring target 16 for monitoring by using the integration console 15. Any type of display format of the integration console 15 may be employed. In other words, a screen displayed by the integration console 15 may be a GUI display screen or a CUI display screen.

The input unit 46b is an input device for receiving an input from the operator 11.

The output unit 47b is an output device for notifying the operator 11 of predetermined information.

The transmission/reception unit 48b is a device for transmitting/receiving information via the network 49.

Information processing of the components of the monitoring terminal B 43b described above can specifically be realized by hardware resources. Specifically, the monitoring terminal B 43b can be realized by a computer 1601. The configuration of the computer 1601 has been described referring to FIG. 6, and thus description thereof will be omitted.

The input unit 46b can be realized by the input device 1607 such as a mouse or a keyboard. The output unit 47b can be realized by the output unit 1608 such as a monitor. The transmission/reception unit 48b can be realized by the communication interface 1606 such as a NIC. The integration console 15 can be realized by loading a predetermined program stored in the external storage device 1604 on the main memory 1603 and executing the program via the CPU 1602.

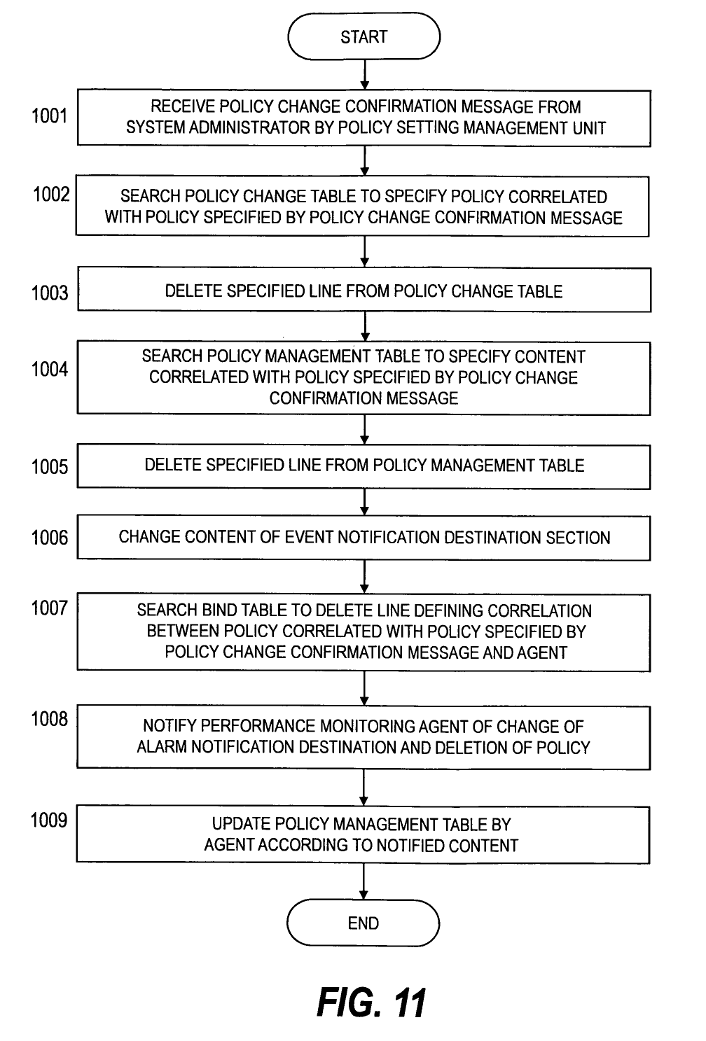

FIG. 9 is a sequential diagram illustrating an overall process of the information processing system according to the embodiment of this invention.

The system administrator 10 transmits a policy change request message specifying a policy to be changed, policy changed contents, and a performance monitoring agent from the monitoring console 14 of the monitoring terminal A 43a (Step 801).

The policy change request message transmitted by the system administrator 10 will be described.

During the operation of the information processing system, the performance monitoring agent 13 monitors a metric value of a monitoring target 16 based on a policy applied to the performance monitoring agent 13, and issues a predetermined event based on a monitoring result (specifically, for example, the monitoring result is transmitted to the integration console 15). The operator 11 who refers to the integration console 15 can manage the information processing system based on the event. The policy applied to issue an event provided to the operator 11 to manage the information processing system is also referred to as a production-environment policy.

However, as the production-environment policy is not proper, no proper event may be issued. The case where no proper event is issued is, for example, the case where even if an abnormality occurs in the monitoring target 16, no event is issued to notify the abnormality, or the case where even if no abnormality occurs in the monitoring target 16, an event is issued to notify an abnormality.

In such a case, the system administrator 10 can change the production-environment policy to make it proper. The policy change request message is transmitted to change the policy in such a case.

As described below, when a policy change request message specifying a production-environment policy as a changing target and changed contents of the production-environment policy is issued, an investigation policy correlated with the production-environment policy is generated. The investigation policy is generated by reflecting the changed contents specified by the policy change request message in the production-environment policy. In other words, the investigation policy is a policy candidate after changing of the production-environment policy correlated therewith. The investigation policy is used for investigating whether the changed contents of the production-environment policy are proper.

In the example of FIG. 9, a first policy is a production-environment policy, and a second policy is an investigation policy. However, when a policy change confirmation message is issued, as a result, the second policy is applied as a new production-environment policy replacing the first policy to the performance monitoring agent 13.

Examples of policy changed contents are as follows. Note, however, that changed contents are not limited to these shown below.

A first example is a change made to increment a threshold value, such as a change of a monitoring condition “CPU USAGE>80%” to a monitoring condition “CPU USAGE>90%”. Conversely, a change may be to decrement a threshold value.

A second example is a change of a monitored metric such as a change of a monitoring condition “CPU USAGE>80%” to a monitoring condition “FREE MEMORY SIZE>50 MB”.

A third example is a change of a policy monitoring conditional expression such as a change of a monitoring condition “CPU USAGE>80%” to a monitoring condition of “CPU USAGE>80% AND FREE MEMORY SIZE>50 MB”. Alternatively, when monitoring is carried out only based on a policy of a monitoring condition “CPU USAGE>80%”, a change may be to add a new policy of a monitoring condition “FREE MEMORY SIZE>50 MB”. Upon addition of the policy, judgment is made based on the monitoring condition of each policy. Conversely, a change may be to delete the policy.

A fourth example is a change of alarm event contents such as a change of an event issued when an abnormal threshold value is exceeded from “NOTIFY OPERATOR BY MAIL” to “EXECUTE COMMAND”.

A fifth example is a change of an alarm judging frequency from “ISSUE ALARM WHEN THRESHOLD VALUE IS EXCEEDED TWICE OUT OF THREE TIMES” to “ISSUE ALARM WHEN THRESHOLD VALUE IS EXCEEDED EVEN ONCE”.

Upon reception of the policy change request message, the performance monitoring manager 12 newly generates a second policy by copying a first policy, and applies policy changed contents specified in Step 801 to the second policy (Step 802). It should be noted that the first policy is a policy specified as a changing target by the policy change request message.

Further, the performance monitoring manager 12 changes an event notification destination of the second policy to “MONITORING CONSOLE 14”.

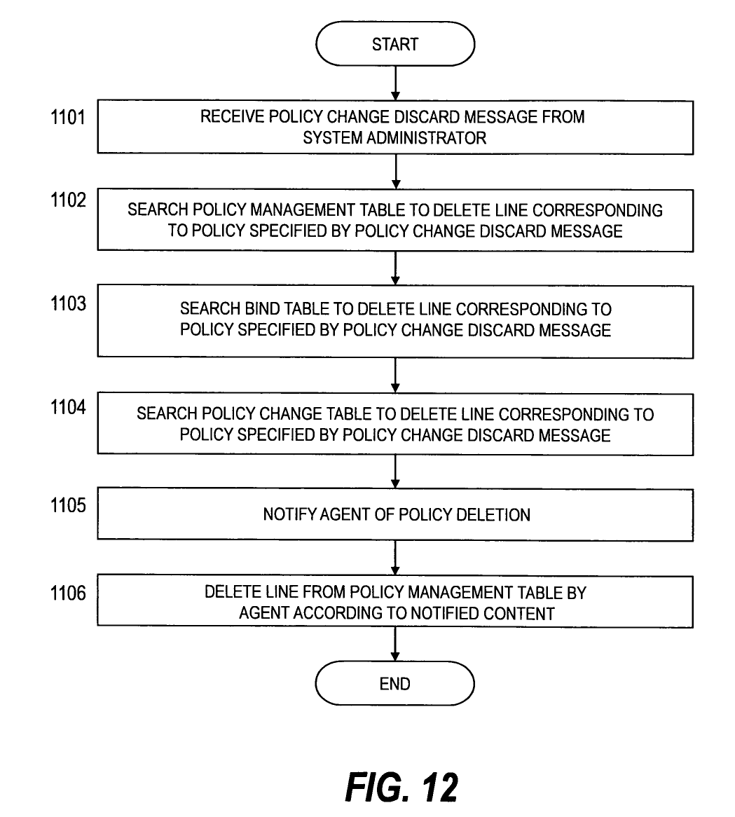

Specifically, in Step 802, the performance monitoring manager 12 adds a new line to the policy management table 250. Then, the performance monitoring manager 12 registers contents identical to those stored in a line corresponding to the first policy in the added new line. Then, the performance monitoring manager 12 changes a content of a policy ID section 250a of the added line to a value for uniquely identifying the second policy. Also, the performance monitoring manager 12 changes contents of the added line (e.g., contents of the alarm condition section 250b and the judging frequency section 250c) to contents specified by the policy change request message. Also, the performance monitoring manager 12 changes a content of the event notification destination section 250e of the added line to “MONITORING CONSOLE 14”. These processes will be described below referring to FIG. 10.

As a result, contents of the newly generated second policy are identical to those of the first policy except for the portions changed in Step 802.

Further, the performance monitoring manager 12 stores information indicating the generation of the second policy from the first policy (in other words, information correlating the first and second policies with each other) (Step 803). Specifically, first and second policy identifiers are respectively stored in the before-change policy ID section 240a and the after-change policy ID section 240b of one line of the policy change table 240.

Then, the performance monitoring manager 12 notifies the performance monitoring agent 13 of a processing result of the policy changed contents of Step 802 (Step 804).

The performance monitoring agent 13 notified of the changed contents changes information regarding a policy which the performance monitoring agent 13 uses for monitoring based on the changed contents, and alarm-monitors the monitoring target 16 based on the changed information.

Specifically, upon reception of the notification of Step 804, the performance monitoring agent 13 executes alarm-monitoring based on the first and second policies. In other words, when monitoring conditions defined by the first policy are satisfied, the performance monitoring agent 13 issues an event defined by the first policy to the integration console 15. Also, when monitoring conditions defined by the second policy are satisfied, the performance monitoring agent 13 issues an event defined by the second policy to the monitoring console 14.

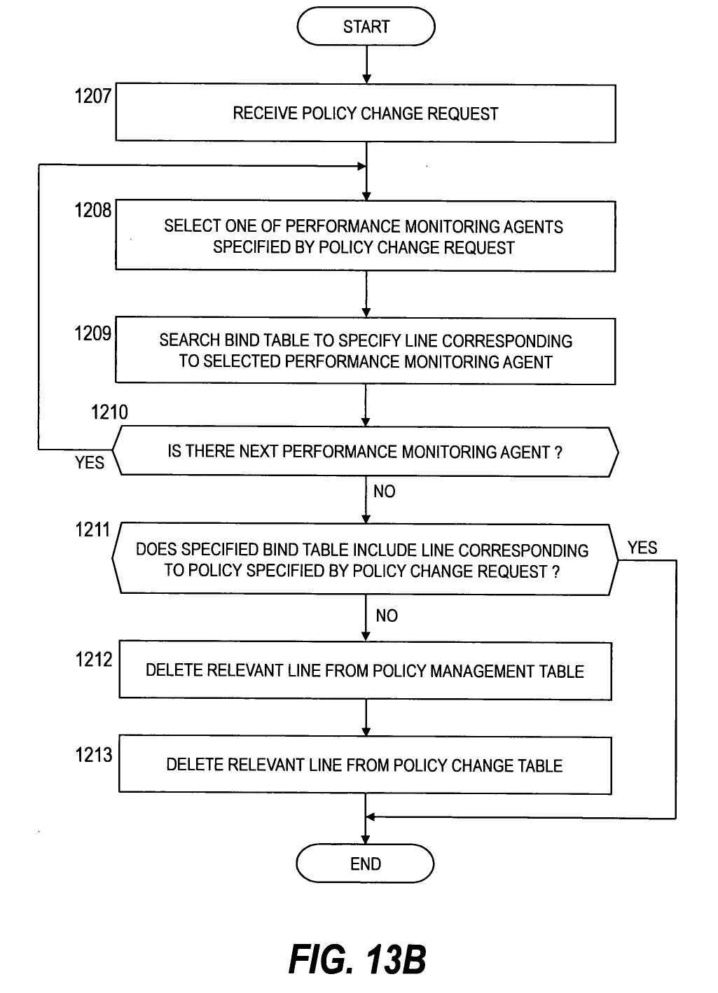

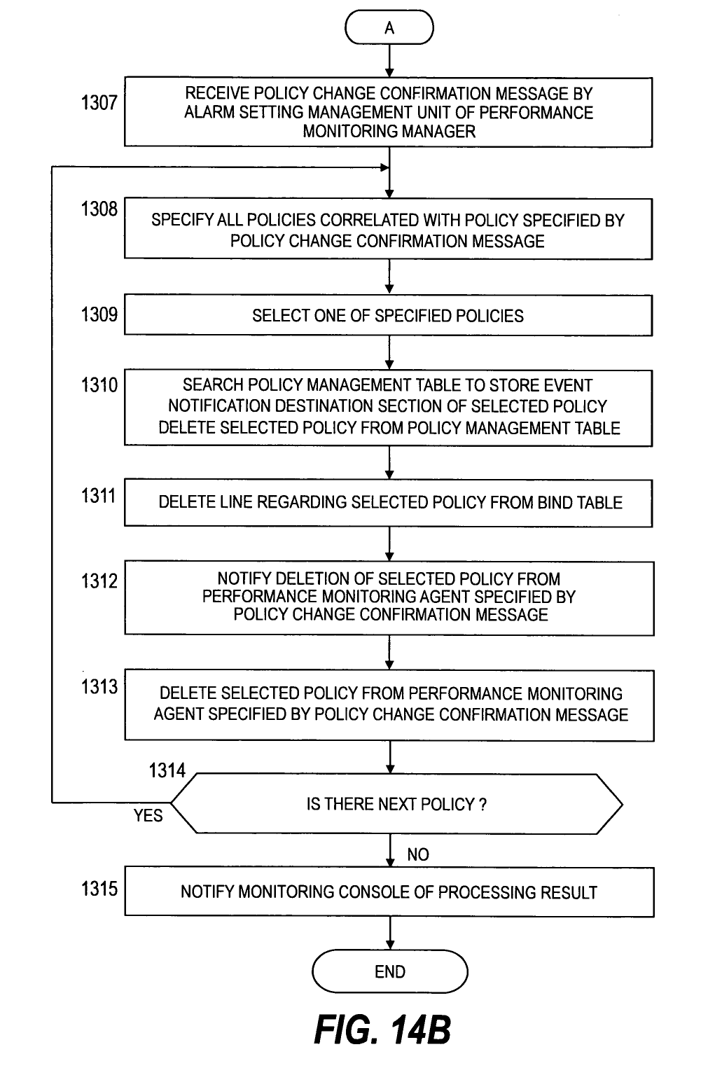

The system administrator 10 can judge whether the second policy is proper by referring to the issued event based on the second policy. Upon judging that the second policy is proper, the system administrator 10 transmits a policy change confirmation message specifying the second policy as a confirming target (Step 805). Upon judging that the second policy is not proper, the system administrator 10 transmits a policy change discard message specifying the second policy as a discarding target as shown in FIG. 12. Alternatively, the system administrator 10 may transmit another policy change request message targeting the first or second policy as shown in FIG. 14A or 14B.

After this process, the system administrator 10 transmits a second policy change confirmation message from the monitoring console 14 of the monitoring terminal A 43a to the performance monitoring manager 12 (Step 805).

Upon reception of the second policy change confirmation message from the system administrator 10, the performance monitoring manager 12 executes a change reflection process.

It should be noted that the change reflection process may be executed upon reception of the policy change confirmation message transmitted from the system administrator 10 as described above, but the process may be executed upon reception of another event. For example, by using a timer, whether a predetermined period of time has passed from execution of policy copying upon reception of the change request message may be periodically judged. When the predetermined period of time is judged to have passed, the policy change reflection process may be executed.

Then, the performance monitoring manager 12 refers to the correlation information stored in Step 803 to retrieve the first policy correlated with the second policy (Step 806).

Then, the performance monitoring manager 12 reflects contents of the second policy which is an investigation policy in the first policy which is a production-environment policy. Specifically, the performance monitoring manager 12 executes, for example, processes of Step 807 and after described below.

The performance monitoring manager 12 refers to event notification destination information set in the first policy (in other words, event notification destination section 250e corresponding to the first policy) (Step 807).

Then, the performance monitoring manager 12 changes contents of event notification destination information of the second policy to those of the event notification destination information of the first policy (Step 808). For example, in the case where event notification destinations of the first and second policies are respectively “INTEGRATION CONSOLE 15” and “MONITORING CONSOLE 14”, the event notification destination of the second policy is changed to “INTEGRATION CONSOLE 15” in Step 808.

Then, the performance monitoring manager 12 discards the first policy, and also discards the correlation information of the first and second policies stored in Step 803 (Step 809). Specifically, the performance monitoring manager 12 deletes the line defining the first policy from the policy management table 250. Also, the performance monitoring manager 12 deletes the line stored in Step 803 from the policy change table 240.

Then, the performance monitoring manager 12 notifies the performance monitoring agent 13 of the policy changed contents (Step 810). Upon reception of the notification, the performance monitoring agent 13 reflects the notified changed contents in the policy management table 310. As a result, for example, the line defining the first policy is deleted from the policy management table 310.

As described above, according to this embodiment, the investigation policy is used as a new production-environment policy by rewriting the content of the event notification destination information of the second policy with “INTEGRATION CONSOLE 15” and by discarding the first policy. As a result, change is reflected in the production-environment policy. However, for example, by rewriting contents other than the event notification destination information with contents similar to those of the second policy and by discarding the second policy, the change may be reflected in the production-environment policy.

Through such a processing operation, the event issued based on the first policy before the policy change is reflected is notified to the integration console 15, and referred to by the operator 11.

Further, when a change request message for changing the first policy is transmitted to generate a second policy, an event issued based on the second policy during a period from the transmission of the policy change request message to transmission of a policy change confirmation message is notified to the monitoring screen of the monitoring console 14, and referred to by the system administrator 10. Also, the event issued based on the first policy in this case is notified to the integration console 15, and referred to by the operator 11.

The event issued based on the second policy after the policy change reflection is notified to the integration console 15, and referred to by the operator 11. After the policy change reflection, the first policy is discarded. Thus, no more events based on the first policy are issued.

Thus, while the system administrator 10 executes investigation for changing the first policy, the event of the second policy generated by adding a change to the copy of the first policy is notified to the monitoring console 14. Accordingly, the system administrator 10 can perform investigation regarding change of setting of contents of the first policy (in other words, investigation to judge whether the change is proper) by using the second policy.

On the other hand, the operator 11 can monitor the production environment by using the first policy until a policy change confirmation message is issued. After the issue of the policy change confirmation message, the operator 11 can monitor the production environment by using the second policy.

Until the policy change confirmation message is issued, the second policy is an investigation policy for judging whether the change of the contents of the first policy is proper. When the monitoring conditions set in the second policy by the system administrator 10 are too strict, even events originally unnecessary to be issued may be issued. Specifically, for example, even when no failure actually occurs in the monitoring target 16, an event regarding a failure occurrence may be issued. Conversely, when the monitoring conditions set in the second policy by the system administrator 10 are too softened, events originally necessary to be issued may not be issued. Specifically, even when a failure actually occurs in the monitoring target 16, no necessary event may be issued. Thus, when such an event based on the second policy is received by the operator 11, erroneous detection or overlooking of failures may disadvantageously occur.

However, as described above referring to FIG. 9, until the system administrator 10 confirms that the monitoring conditions of the second policy are proper to transmit a policy change confirmation message, the event issued based on the second policy is not notified to the operator 11. Accordingly, according to this embodiment, erroneous detection or overlooking of failures by the operator 11 can be reduced.

According to this embodiment described above, in Step 802, the event notification destination of the first policy may not be changed or the monitoring console 14 may be added to the event notification destination of the first policy.

In the case where the monitoring console 14 is added to the event notification destination of the first policy, during the period from the transmission of the policy change request message to the transmission of the policy change confirmation message, the system administrator 10 can monitor both of the events based on the first and second policies through the monitoring console 14 of the monitoring terminal A 43a. Accordingly, investigation can be performed regarding policy changes by comparing a monitoring result based on an original policy as a changing request target with a monitoring result based on a policy changed based on the change request.

According to the above-mentioned embodiment, the policy change request message is transmitted in Step 801, and the policy change confirmation message is transmitted in Step 805. Instead, however, the operator 11 may specify a policy identifier from the monitoring console 14 of the monitoring terminal A 43a to transmit a policy change discard message. Upon reception of the policy change discard message, the performance monitoring manager may discard a policy concerning the policy identifier specified by the policy change discard message, and return policy information correlated with the discarded policy to the monitoring console 14.

Thus, for example, the system administrator 10 can cancel changing of a production-environment alarm to the second policy after changing a content of a threshold value of the investigation second policy generated from the first policy to change and adjust the production-environment first policy and then judging that neither change nor adjustment is necessary.

Also, in place of Step 805 of this embodiment described above, when the system administrator transmits a request message for resetting a policy change request, the contents of the second policy may be returned to those of the first policy by using stored correlation information between the policies.

Accordingly, for example, after changing of the content of the threshold value of the investigation second policy generated from the first policy to change and adjust the production-environment first policy, the system administrator 10 can return the threshold value of the investigation second policy to the threshold value set in the production-environment first policy. Also, the system administrator can return the investigation second policy to the value set in the first policy to perform another investigation.

This process will be described below in detail referring to FIG. 12.

According to this embodiment described above, the system administrator specifies the performance monitoring agent 13 in the policy change request message in Step 801, and notifies the specified performance monitoring agent 13 of the policy change in Step 804. However, the policy change request message does not have to specify any performance monitoring agent 13 in Step 801. In this case, before execution of Step 804, the performance monitoring manger 12 refers to the bind table 230 to specify a performance monitoring agent 13 to which the policy specified by the policy change request message has been applied. When the specified policy is applied to a plurality of performance monitoring agents 13, all the performance monitoring agents 13 are specified.

Then, the performance monitoring manager 12 notifies all the specified performance monitoring agents 13 of changing of the policy in Step 804, and specifies a changed policy to transmit a policy change confirmation message in Step 805. Then, the performance monitoring manager 12 refers to a policy of the specified policy before changing in Step 806, and then refers to all the performance monitoring agents 13 correlated with the policy before changing to process Steps 808 and 809, thereby notifying all the performance monitoring agents 13 of a processing result in Step 810.

Thus, as the policy changing can be adjusted for the plurality of performance monitoring agents altogether, the system administrator can perform policy investigation for monitoring a plurality of monitoring targets 16 in parallel for each of the monitoring targets 16.

According to this embodiment described above, the policy change request message is transmitted in Step 801, and the policy change confirmation message is transmitted in Step 805. However, before execution of Step 805, the system administrator 10 may further specify a second policy to transmit a policy change request message through the monitoring console 14 of the monitoring terminal A 43a. In this case, the performance monitoring manager 12 executes Step 802 again to copy the second policy, and changes a copied new policy according to the policy change request message to generate a third policy. Then, the performance monitoring manager 12 stores information associating the second policy and the third policy in the policy change table 240 in Step 803, and notifies the performance monitoring agent 13 of addition of the third policy in Step 804.

Accordingly, before transmission of the policy change confirmation message, the system administrator 10 can transmit the change request messages more than once.

Accordingly, events based on the second and third policies are also both notified to the monitoring console 14 monitored by the system administrator 10. Thus, contents of the second and third policies can simultaneously be investigated.

Further, the performance monitoring manager 12 may receive the policy change confirmation message specifying a policy in Step 805, refer to all the policies correlated with the specified policy in Step 806, discard the policies other than the specified policy among the policies referred to in Step 809 and correlation information regarding the policies other than the specified policy, and notify the agent of a processing result in Step 810.

This process will be described below in detail referring to FIGS. 14A and 14B.

In Step 809 of the process, the performance monitoring manager 12 does not have to discard the policies other than the specified policy among the policies referred to or the stored correlation information regarding the policies other than the specified policy.

In such a case, even after the transmission of the policy change confirmation message, the system administrator 10 can refer to the policy information before the transmission of the policy change request message, and can also return the contents of the policy after the transmission of the policy change confirmation message to those of the policy information before the transmission of the policy change request message.

According to this embodiment described above, the performance monitoring manager 12 can also store issuing history information of the policy change request message and the policy change confirmation message and issuer information for identifying a person who has issued the policy change request message and the policy change confirmation message as pieces of log information. For example, in Step 805, when confirming a change, the performance monitoring manager 12 may correlate the contents of a policy change confirmation process and issuer information for identifying a person who has issued a policy change confirmation message with time of issuing the requests to store them as logs.

Accordingly, the policy change history can be investigated by tracing the past information. A result of the investigation may be used for, for example, investigating policy change mistakes or used as information supplied for investigation. When a plurality of system administrators 10 simultaneously change the same policy, changed contents of a certain system administrator 10 may disadvantageously be lost depending on issue timings of a policy change request message and a policy change confirmation message. However, by using the pieces of log information of the policy change processing history information and the changing processing issuer information, simultaneous changing of a policy can be prevented providing exclusive permission of a changing process, a warning can be issued on reflection of a change, or an unintentionally discarded policy can be recovered to retrospectively apply a change.

FIG. 10 is a flowchart illustrating a process executed when the system administrator 10 issues a policy change request message according to the embodiment of this invention.

The flowchart of FIG. 10 illustrates Steps 801 to 804 of the process shown in FIG. 9 in detail.

The policy setting management unit 19 receives the policy change request message which the system administrator 10 has transmitted from the monitoring terminal A 43a via the transmission/reception unit 45. The policy setting management unit 19 substitutes a performance monitoring agent 13, an instance, a policy, a policy changed content specified in the policy change request message for variables X1, X2, B1, and Y, respectively (Step 901). In other words, the variable B1 is an identifier of the first policy shown in the example of FIG. 9, and the variable X1 is an identifier of a performance monitoring agent to which the first policy is applied.

Next, the policy setting management unit 19 searches the policy management table 250 to extract a line where the policy ID section 250a matches the variable B1 as a variable B (Step 902). The extracted line includes contents of a policy (in other words, first policy) specified in the policy change request message.

Next, the policy setting management unit 19 adds a new line to the policy management table 250. The added line is a variable A. Also, the policy setting management unit 19 generates a policy identifier yet to be registered in the policy ID section 250a of the policy management table 250 as a variable A1, and substitutes the variable A1 for the policy ID section 250a of the added line. The variable A1 is an identifier for uniquely identifying the second policy in the example of FIG. 9. The policy setting management table 19 substitutes the changed content of the variable Y for a section corresponding to a changed content of the variable Y in the added line. The other sections are substituted with values of sections corresponding to the variable B (Step 903).

Accordingly, a content of the second policy is newly stored in the variable A. The content of the second policy is generated by reflecting the changed content specified by the policy change request message in the content of the first policy.

Next, the policy setting management unit 19 adds a new line to the bind table 230. The added new line is a variable J. The policy setting management unit 19 substitutes values of the variables A1, X1, and Y1 for the policy ID section 230a, the agent section 230b, and the instance section 230c of the added line, respectively (Step 904). Accordingly, information correlating the performance monitoring agent 13 to which the first policy has been applied with the newly generated second policy is stored. The newly generated second policy is further applied to the performance monitoring agent 13 to which the first policy has been applied.

Next, the policy setting management unit 19 adds a new line to the policy change table 240. The added new line is a variable K. The policy setting management table 19 substitutes the variable A1 and the variable B1 for the before-change policy ID section 240a and the after-change policy ID section 240b of the added line (Step 905). Accordingly, information correlating the first policy (in other words, production-environment policy of current time) with the second policy derived from the first policy (in other words, investigation policy of current time) is stored in the policy change table 240.

Next, the policy setting management unit 19 notifies the policy setting distribution unit 18 of the variables X1, X2 and A, and a policy change process. The policy setting distribution unit 18 that has received the notification notifies the policy setting management unit 28 of the performance monitoring agent 13 corresponding to the variables X1 and X2 of a policy addition request message specifying contents of the variable A (Step 906).

The policy setting management unit 28 of the performance monitoring agent 13 that has received the policy addition request message adds a new line to the policy management table 310, and substitutes the contents specified by the variable A for the new line (Step 907). As a result, in addition to the first policy, the second policy is applied to the performance monitoring agent 13.

The alarm judgment unit 27 judges whether performance information stored in the collected record table 320 satisfies a conditional expression stored in the alarm condition section 310b of a policy corresponding to the variable A of the policy management table 310. Upon judging that the conditional expression is satisfied, the alarm judgment unit 27 executes an event content stored in the event content section 310d via the event issue unit 26, and notifies the event notification destination stored in the event notification destination section 310e of it.

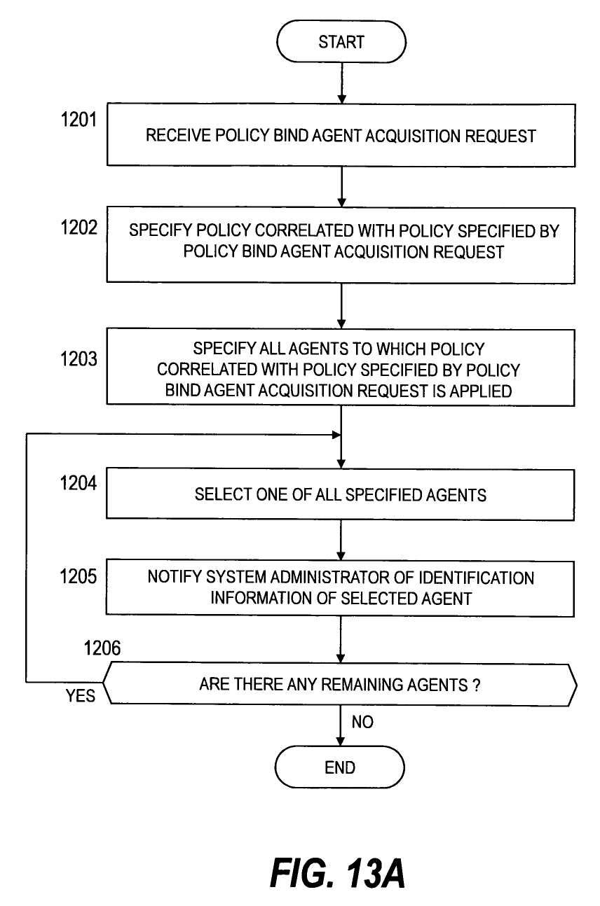

FIG. 11 is a flowchart illustrating a process executed when the system administrator 10 issues a policy change confirmation message according to the embodiment of this invention.

The flowchart of FIG. 11 illustrates Steps 805 to 810 of the process shown in FIG. 9 in detail.

Upon reception of the policy change confirmation message from the system administrator 10, the policy setting management unit 19 substitutes a policy, a performance monitoring agent 13, and an instance specified in the policy change confirmation message for the variables I, X1 and X2, respectively (Step 1001). The policy specified by the variable I is the second policy in the example of FIG. 9.

The policy setting management table 19 searches the policy change table 240 to extract a line where a value stored in the after-change policy ID section 240b matches a value of the variable I as a variable A. The policy setting management unit 19 substitutes the value stored in the before-change policy ID section 240a of the variable A for the variable J (Step 1002). Then, a policy specified by the variable J is the first policy in the example of FIG. 9.

Next, the policy setting management unit 19 deletes the line extracted in Step 1002 from the policy change table 240 (Step 1003). The deleted line is a record storing correlation information between the first and second policies in the example of FIG. 9.

The policy setting management unit 19 searches the policy management table 250 to extract a line where a value stored in the policy ID section 250a matches the value of the variable J, and substitutes the line for the variable B (Step 1004). The variable B is a record storing a policy definition content of the first policy in the example of FIG. 9.

Next, the policy setting management unit 19 deletes the line extracted in Step 1004 from the policy management table 250 (Step 1005).

Next, the policy setting management unit 19 searches the policy management table 250 to extract a line where a value stored in the policy ID section 250a matches the value of the variable B as a variable C. Then, the policy setting management unit 19 substitutes a content of the event notification destination section 250e of the variable B for the event notification destination section 250e of the variable C (Step 1006). For example, when “MONITORING CONSOLE 14” has been stored in the event notification destination section 250e of the second policy of FIG. 9, and “INTEGRATION CONSOLE 14” has been stored in the event notification destination section 250e of the first policy, the content of the event notification destination section 250e corresponding to the second policy is changed to “INTEGRATION POLICY 14” in Step 1006.

Next, the policy setting management unit 19 searches the bind table 230 to extract a line where a value stored in the policy ID section 230a matches the value of the variable B, where a value stored in the agent section 230b matches the value of the variable X1, and where a value stored in the instance section 230c matches the value of the variable X2. Then, the policy setting management unit 19 deletes the extracted line from the bind table 230 (Step 1007). The deleted line is a record storing correlation information between the first policy and the performance monitoring agent 13.

The policy setting distribution unit 18 notifies the performance monitoring agent 13 specified by the variables X1 and X2 of a message for requesting changing of an alarm notification destination of the variable C and deletion of a policy of the variable B (Step 1008).

The policy setting management unit 28 of the performance monitoring agent 13 adds a new line to the policy management table 310 read from the policy management table storage area 31 to reflect the content of the variable C on the line. Also, the policy setting management unit 28 searches the policy management table 310 to delete a line where a policy ID section 310a matches the variable B (Step 1009). The performance monitoring manager 12 notifies the performance monitoring agent 13 of the process of deleting the first policy to rewrite a notification destination of the second policy.

As a result of deleting the first policy, monitoring of a metric value of the monitoring target 16 based on the first policy and transmission of the monitoring result carried out by the performance monitoring agent 13 are stopped.

Thereafter, the performance monitoring agent 13 monitors the monitoring target 16 based on the second policy, and transmits an event based on the monitoring result to the integration console 15.

Thus, the system administrator 10 can execute a policy changing process and a policy application process (in other words, processing of confirming the change) even during alarm-monitoring of the operator 11 only by transmitting a policy change request message and a policy change confirmation message without being aware of which policy a before-change policy is. On the other hand, the operator 11 can perform alarm-monitoring without being aware of the policy changing process of the system administrator 10.

It should be noted that Steps 1003 and 1005 are not always necessary. In other words, change history may be held without executing these steps. Thus, the system administrator 10 can return, after a change of a policy used for monitoring by the operator 11 is confirmed, the policy to a policy before policy change confirmation.

FIG. 12 is a flowchart illustrating a process executed when a request for discarding a policy change is issued according to the embodiment of this invention.

Specifically, FIG. 12 illustrates a process executed when a request for discarding a change of the second policy generated for change investigation is issued after a change request of the first policy is issued.

The policy setting management unit 19 receives a policy change discard message from the system administrator 10. The policy change discard message contains a policy ID for specifying a policy requested to be discarded. The policy setting management unit 19 substitutes the policy ID specified in the policy change discard message for the variable I, and an agent name and instance name of an agent and instance to which the policy is applied respectively for the variables X1 and X2 (Step 1101). For example, the variable I is an identifier of the second policy.

Next, the policy setting management table 19 searches the policy management table 250 to extract a line where a value stored in the policy ID section 250a matches a value of the variable I, and deletes the line (Step 1102). Accordingly, information defining contents of the second policy is deleted from the policy management table 250.

Next, the policy setting management unit 19 searches the bind table 230 to extract a line where a value stored in the policy ID section 230a matches the variable I, where a value stored in the agent section 230b matches the variable X1, and where a value stored in the instance section 230c matches the variable X2. Then, the policy setting management unit 19 deletes the extracted line from the bind table 230 (Step 1103). Accordingly, for example, information correlating the second policy with the performance monitoring agent 13 to which the second policy is applied from the bind table 230.

Next, the policy setting management unit 19 searches the policy change table 240 to extract a line where a value of the after-change policy ID section 240b matches the variable X1. Then, the policy setting management unit 19 deletes the extracted line from the policy change table 240 (Step 1104). Accordingly, for example, information correlating the second policy with the first policy is deleted from the policy change table 240.

Next, the policy setting distribution unit 18 notifies the performance monitoring agent 13 of deletion of the policy identified by the variable I (Step 1105).

The performance monitoring agent 13 searches the policy management table 310 to extract a line where a value of the policy ID section 310a matches the variable I, and deletes the line (Step 1106).

Thus, according to this embodiment, the system administrator 10 can return the content of the changed and investigated policy to that of the policy before the change. In the information processing system, when a second policy is generated from a first policy based on a policy change request, the system administrator 10 can return a content of the second policy to that of the first policy before investigation and changing by transmitting a policy change discard message for the second policy.

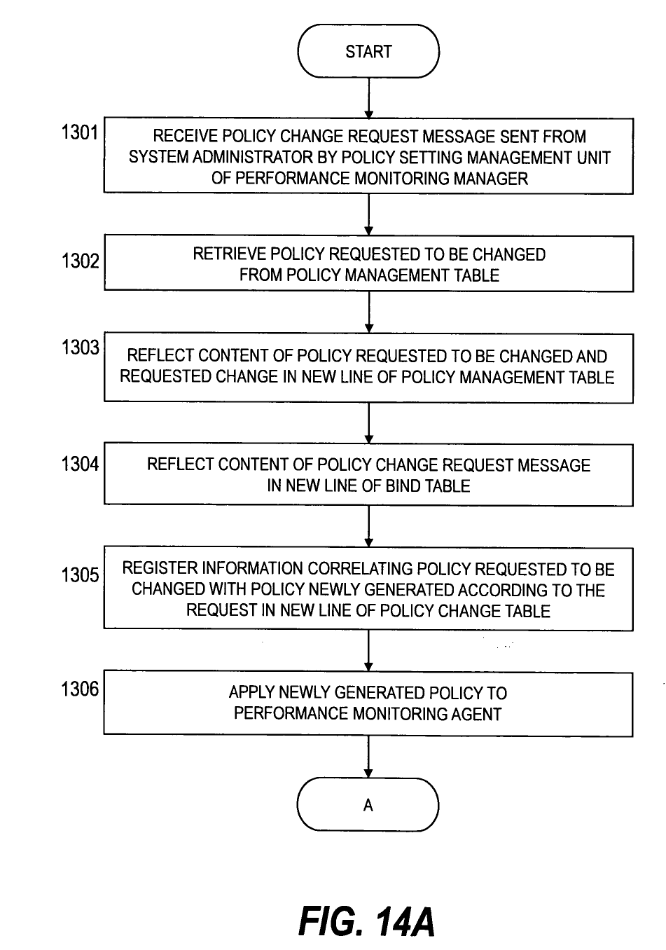

Each of FIGS. 13A and 13B is a flowchart illustrating a process executed to reflect a policy change in a plurality of performance monitoring agents 13 according to the embodiment of this invention.

Specifically, each of FIGS. 13A and 13B illustrates a process executed to perform setting change investigation (in other words, investigation as to whether a change is proper) of a first policy for a certain agent after reception of a change request of the first policy applied to the plurality of performance monitoring agents 13, and to reflect a changed content in the other agents to which the first policy is applied.

Next, the policy setting management unit 19 receives a policy bind agent acquisition request from the system administrator. The policy setting management unit 19 substitutes a policy ID specified by the policy bind agent acquisition request for the variable I (Step 1201).

Next, the policy setting management table 19 searches the policy change table 240 to extract a line where a value stored in the after-change policy ID section 240b matches the variable I, and stores the extracted line as a variable A. The policy setting management unit 19 substitutes a value stored in the before-change policy ID section 240a of the variable A for the variable J (Step 1202). By the variable J, a policy correlated with a policy specified by the policy bind agent acquisition request is specified.

Next, the policy setting management unit 19 searches the bind table 230 to extract all lines where values of the policy ID sections 230a match the variable J, and stores the extracted lines as variables B (Step 1203). By the agent section 230b of the variable B, all performance monitoring agents 13 to which the policy correlated with the policy specified by the policy bind agent acquisition request are specified.

Next, the policy setting management unit 19 selects one of the elements of the variable B, and stores the selected element as a variable B1 (Step 1204).

Next, the policy setting management unit 19 substitutes a value of the agent section 230b of the variable B1 for a variable B3 and a value of the instance section 230c for a variable B4. The policy setting management unit 19 notifies the system administrator of the variables B3 and B4 (Step 1205).

Next, the policy setting management unit 19 judges whether there is a next element (in other words, an element yet to be extracted as the variable B1) in the variable B (Step 1206). If a result of the judgment of Step 1206 shows that there is a next element, the process returns to Step 1204. If a result of the judgment of Step 1206 shows that there is no next element, the process proceeds to Step 1207.

When the policy correlated with the policy specified by the policy bind agent acquisition request is applied to a plurality of performance monitoring agents 13, through the process up to Step 1206, pieces of identification information of all the performance monitoring agents 13 are notified to the system administrator 10.

The policy setting management unit 19 receives a policy change request. The policy setting management unit 19 substitutes a policy ID specified by the policy change request for the variable J and a combination of the variables B3 and B4 for the variable C (Step 1207).

Next, the policy setting management unit 19 selects one of the elements of the variable C to store it as a variable C1. The policy setting management unit 19 substitutes a value of the agent section of the variable C1 for a variable D1 and a value of the instance section of the variable C1 for a variable D2 (Step 1208). Accordingly, one of the plurality of performance monitoring agents 13 to which the policy specified by the policy change request is applied is selected.

Next, the policy setting management unit 19 searches the bind table 230 to extract a line where a value of the policy ID section 230a matches the variable J, where a value of the agent section 230b matches the variable D1, and where a value of the instance section 230c matches the variable D2. The policy setting management unit 19 substitutes the value of the policy ID section 230a of the extracted line for the variable I (Step 1209). Accordingly, a line of the bind table 230 corresponding to the performance monitoring agent 13 selected in Step 1208 is specified.

Next, the policy setting management unit 19 judges whether there is a next element (in other words, an element yet to be selected as the variable C1) in the variable C (Step 1210). If a result of the judgment of Step 1210 shows that there is a next element, the process returns to Step 1208. If a result of the judgment of Step 1210 shows that there is no next element, all the lines of the bind table 230 corresponding to the plurality of performance monitoring agents 13 to which the policy specified by the policy change request have been specified. In this case, the process proceeds to Step 1211.

Next, the policy setting management unit 19 searches each line of the bind table 230 to judge whether there is a line where a value of the policy ID section 230a matches the variable J (Step 1211). If a result of the judgment of Step 1211 shows that there is a matched line, the policy setting management unit 19 finishes the process. If a result of the judgment of Step 1211 shows that there is no matched line, the process proceeds to Step 1211.

Next, the policy setting management unit 19 searches the policy management table 250 to delete a line where a value of the policy ID section 250a matches the variable J (Step 1212).

Next, the policy setting management unit 19 retrieves each line of the policy change table 240 to extract a line where a value of the before-change policy ID section 240a matches the variable J and where a value of the after-change policy ID section 240b matches the variable I. The policy setting management unit 19 deletes the extracted line from the policy change table to finish the process (Step 1213).

Thus, according to this embodiment, the system administrator 10 can perform, by specifying a policy to be change-investigated and a performance monitoring agent 13 of a change investigation target to transmit a policy change request message, change investigation by using the performance monitoring agent 13 specified regarding the specified policy.

Further, a plurality of performance monitoring agents 13 may execute alarm-monitoring by using one policy. In such a case, according to this embodiment, when the system administrator 10 transmits a policy change confirmation message, a change of a policy specified by the policy change confirmation message can be reflected not only in a performance monitoring agent 13 specified by the policy change confirmation message but also in other performance monitoring agents 13 engaged in monitoring by using the policy specified by the policy change request message.

Each of FIGS. 14A and 14B is a flowchart illustrating a process executed for generating another investigation policy from an investigation policy according to the embodiment of this invention.

Specifically, each of FIGS. 14A and 14B illustrates a process executed when a policy change request message specifying a second policy is issued before a policy change confirmation message for the second policy is issued after the second policy is generated based on a policy change request message of a first policy.

The process of FIGS. 14A and 14B is carried out after Step 907 of FIG. 10 is finished.

The system administrator 10 transmits a policy change request message specifying a performance monitoring agent 13, an instance, a policy and policy changed contents from the monitoring console 14 of the monitoring terminal A 43a. The policy setting management unit 19 of the performance monitoring manager 12 receives this policy change request message from the transmission/reception unit 44 (Step 1301). Contents of the performance monitoring agent 13 and the instance specified in the policy change request message are respectively identical to those of the variables X1 and X2 of Step 901. The policy specified in the policy change request message is identical to the content of the variable A1. The policy corresponding to the variable A1 is a second policy. In other words, the policy change request message is the one that requests generation of a new investigation policy (in other words, third policy) from the second policy which is a current investigation policy.

The policy setting management unit 19 substitutes the policy changed contents specified in the policy change request message for the variable Y3.

Next, the policy setting management unit 19 searches the policy management table 250 to store a line where a value of the policy ID section 250a matches the variable A1 as the variable A (Step 1302).

Next, the policy setting management unit 19 adds a new line to the policy management table 250. The policy setting management unit 19 stores the added line as the variable C. The policy setting management unit 19 generates a new unique ID in the policy ID section 250a of the policy management table 250, and substitutes the generated ID for the policy ID section 250a of the variable C (Step 1303). The generated ID is set as the variable C1. A policy corresponding to the variable C1 is a third policy.

The policy setting management unit 19 substitutes values equal to those of the variable A for sections other than the policy ID section 250a of the variable C. The policy setting management unit 19 applies a change corresponding to the variable Y3 to the variable C. For example, when the variable Y3 specifies a change of a threshold value, the policy setting management unit 19 changes a threshold value stored in the alarm condition section 250b of the variable C to the threshold value specified by the variable Y3.

Next, the policy setting management unit 19 adds a new line to the bind table 230. The policy setting management unit 19 stores the added line as a variable L. The policy setting management unit 19 substitutes the variables C1, X1 and X2 for the policy ID section 230a, the agent section 230b and the instance section 230c of the variable L, respectively (Step 1304).

The policy setting management unit 19 adds a new line to the policy change table 240. The policy setting management unit 19 stores the added line as a variable M. The policy setting management unit 19 substitutes the variables A1 and C1 respectively for the before-change policy ID section 240a and the after-change policy ID section 240b of the variable M (Step 1305). Accordingly, information correlating the second policy (investigation policy which has been generated) with the third policy derived from the second policy (newly generated investigation policy) is stored in the policy change table 240.

Next, the policy setting management unit 19 notifies the policy setting distribution unit 18 of the contents of the variable C. The policy setting distribution unit 18 that has received the notification notifies the performance monitoring agent 13 of the policy change. The policy setting management unit 28 of the performance monitoring agent 13 notified of the policy change adds a new line to the policy management table 310, and registers the contents of the variable C in the new line (Step 1306). Thus, a newly generated third policy is applied to the performance monitoring agent 13.

Next, a processing operation executed when a policy change confirmation message specifying the third policy thus generated is received will be described.

For example, after the end of Step 1306, the system administrator 10 refers to results of alarm-monitoring carried out by the performance monitoring agent 13 based on the first policy (production-environment policy), the second policy (investigation policy derived from the first policy), and the third policy (investigation policy derived from the second policy). As a result, when the third policy is judged to be the most proper, the system administrator 10 transmits a policy change confirmation message specifying the third policy.

The policy setting management unit 19 of the performance monitoring manager 12 receives the policy change confirmation message (Step 1307). A case will be described as an example where a policy, a performance monitoring agent 13 and an instance specified by the received policy change confirmation message are respectively equal in value to the variables C1, X1, and X2.

The policy setting management unit 19 searches the policy change table 240 to obtain a policy ID list regarding the variable C1, and stores the obtained list as a variable D. For example, the policy setting management unit 19 recursively discovers a before-change policy of the variable C1 (Step 1308).

Specifically, the policy setting management unit 19 retrieves a line where a content of the after-change policy ID section 240b matches the variable C1. The policy setting management unit 19 adds a content of the before-change policy ID section 240a of the retrieved line as a variable D1 which is an element of the variable D. The policy setting management unit 19 also searches the policy change table 240 to add a content of the before-change policy ID section 240a of a line where a content of the after-change policy ID section 240b matches the variable D1 as a variable D2 which is an element of the variable D. The policy setting management unit 19 repeats such a process until there is no line which satisfies the retrieval conditions.

As a result of Step 1308, all policies correlated with the policy specified by the policy change confirmation message are specified, and a policy ID of each of the specified policies is stored as a variable D. The policies correlated with the policy specified by the policy change confirmation message are all polices before a change of the policy specified by the policy change confirmation message (in other words, derivation sources). For example, when the first to third polices are generated as described above, and the second policy is specified by the policy change confirmation message, the first policy is specified in Step 1308. When the third policy is specified by the policy change confirmation message, the first and second policies are specified in Step 1308.

Next, the policy setting management unit 19 selects one of the elements registered in the variable D, and sets the selected element as a variable D1 (Step 1309).

The policy setting management unit 19 searches the policy management table 250 to store a line where a content of the policy ID section 250a matches the variable D1 as a variable N. The policy setting management unit 19 stores a content of the event notification destination section 250e of the variable N. Then, the policy setting management unit 19 deletes the variable N (Step 1310). However, if the policy is applied to a plurality of agents, the variable N is not deleted.

Next, the policy setting management unit 19 searches the bind table 230 to delete a line where contents of the policy ID section 230a, the agent section 230b and the instance section 230c respectively match the variables D1, X1 and X2 (Step 1311).

Next, the policy setting management unit 19 specifies the variables D1, X1 and X2 to notify the policy setting distribution unit 18 of policy deletion. The policy setting distribution unit 18 that has received the notification specifies the variable D1, and instructs the performance monitoring agent 13 specified by the variables X1 and X2 to execute policy deletion (Step 1312).

The policy setting management unit 28 of the performance monitoring agent 13 that has received the instruction deletes a line where a content of the policy ID section 310a matches the variable D1 from the policy management table 310 (Step 1313). Accordingly, the application of the policy corresponding to the variable D1 to the performance monitoring agent 13 is released. In other words, thereafter, this performance monitoring agent 13 will perform no alarm-monitoring based on the policy corresponding to the variable D1.

Next, the policy setting management unit 19 judges whether there is a next element in the variable D. If there is no next element, the process proceeds to Step 1315. If there is a next element, the policy setting management unit 19 selects the next element, and sets the selected element as a new variable D1 to return to Step 1309 (Step 1314).

Next, the policy setting management unit 19 notifies the monitoring console 14 of the processing result (Step 1315).

Next, a process executed to generate a plurality of investigation policies (e.g., second and third policies) from one production-environment policy (e.g., first policy) will be described below. Specifically, a process executed when a plurality of investigation policies are generated regarding the first policy based on a plurality of different policy change request messages, and then a policy change confirmation message for one of the investigation policies is received will be described.

For example, a process executed when two policies, i.e., second and third policies, are generated from the first policy, and the third policy is specified to transmit a policy change confirmation message will be described.

A process executed when policy change request messages are received to generate the second and third policies is identical to that of Steps 901 to 907 of FIG. 10, and thus description thereof will be omitted.

A process executed when a policy change confirmation message specifying a third policy will be described.

It should be noted that Steps 1321 to 1329 described below correspond respectively to Steps 1307 to 1315 of FIG. 14B, and thus they are not shown. Accordingly, “STEP 1321” to “STEP 1329” described below may be replaced with “STEP 1307” to “STEP 1315”. However, a specific process executed in Step 1308 is different from that described above.

The policy setting management unit 19 of the performance monitoring manager 12 receives a policy change confirmation message (Step 1321). As an example, a case where a policy, a performance monitoring agent 13 and an instance specified by the received policy change confirmation message are respectively equal in value to the variables C1, X1 and X2 will be described.

The policy setting management unit 19 searches the policy change table 240 to obtain a policy ID list regarding the variable C1, and stores the obtained list as a variable D. The policy setting management unit 19 extracts a line where a content of the before-change policy ID section 240a matches that of the before-change policy ID section 240a of the variable C1, and stores a content of the after-change policy ID section 240b of the matched line as a variable D (Step 1322).

Specifically, the policy setting management unit 19 retrieves a line where a content of the after-change policy ID section 240b matches the variable C1. The policy setting management unit 19 adds a content of the before-change policy ID section 240a of the retrieved line as a variable D1 which is an element of the variable D. Further, the policy setting management unit 19 searches the policy change table 240 to add a content of the after-change policy ID section 240b of a line where a content of the before-change policy ID section 240a matches the variable D1 as a variable D2 which is an element of the variable D. The policy setting management unit 19 repeats such a process until there is no more line which satisfies the retrieval conditions. It should be noted that the variable C1 is eliminated from the variable D.

As a result of Step 1322, all policies correlated with the policy specified by the policy change confirmation message are specified, and a policy ID of each of the specified policies is stored as a variable D. The policies correlated with the policy specified by the policy change confirmation message are a policy before a change of the policy specified by the policy change confirmation message (in other words, a derivation source), and all investigation policies generated to change the before-change policy. For example, when a first policy as a production-environment policy, a second policy as an investigation policy generated to change the first policy, and a third policy as an investigation policy generated to change the first policy are generated as described above, and the third policy is specified by the policy change confirmation message, the first and second policies are specified in Step 1322.

Next, the policy setting management unit 19 selects one of the elements registered in the variable D, and sets the selected element as a variable D1 (Step 1323).

The policy setting management unit 19 searches the policy management table 250 to store a line where a content of the policy ID section 250a matches the variable D1 as a variable N. The policy setting management unit 19 stores a content of the event notification destination section 250e of the variable N. Then, the policy setting management unit 19 deletes the variable N (Step 1324).

Next, the policy setting management unit 19 searches the bind table 230 to delete a line where contents of the policy ID section 230a, the agent section 230b and the instance section 230c respectively match the variables D1, X1 and X2 (Step 1325).

Next, the policy setting management unit 19 specifies the variables D1, X1 and X2 to notify the policy setting distribution unit 18 of policy deletion. The policy setting distribution unit 18 that has received the notification specifies the variable D1, and instructs the performance monitoring agent 13 specified by the variables X1 and X2 to execute the policy deletion (Step 1326).

The policy setting management unit 28 of the performance monitoring agent 13 that has received the instruction deletes a line where a content of the policy ID section 310a matches the variable D1 from the policy management table 310 (Step 1327). Accordingly, the application of the policy corresponding to the variable D1 to the performance monitoring agent 13 is released. In other words, thereafter, this performance monitoring agent 13 will perform no alarm-monitoring based on the policy corresponding to the variable D1.

Next, the policy setting management unit 19 judges whether there is a next element in the variable D. If there is no next element, the process proceeds to Step 1329. If there is a next element, the policy setting management unit 19 selects the next element, and sets the selected element as a new variable D1 to return to Step 1323 (Step 1328).

Next, the policy setting management unit 19 notifies the monitoring console 14 of the processing result (Step 1329).

It should be noted that upon reception of a policy change request for directly changing the first policy after a policy change request for the first policy is received, the policy setting management unit 19 can execute the process similar to that of Steps 1321 to 329.

The policy change request message for requesting the direct change is, for example, a request for directly changing contents of a policy to monitor a production environment. Upon reception of the request, the performance monitoring manager 12 changes the contents of the production-environment policy without generating any investigation policy by copying the production-environment policy.

Such a policy change request message for directly changing the production-environment policy may be regarded as a combination of the policy change request message described above and a policy change confirmation message. Accordingly, upon reception of the policy change request for directly changing the policy, the policy setting management unit 19 can carry out the same process as that described above.

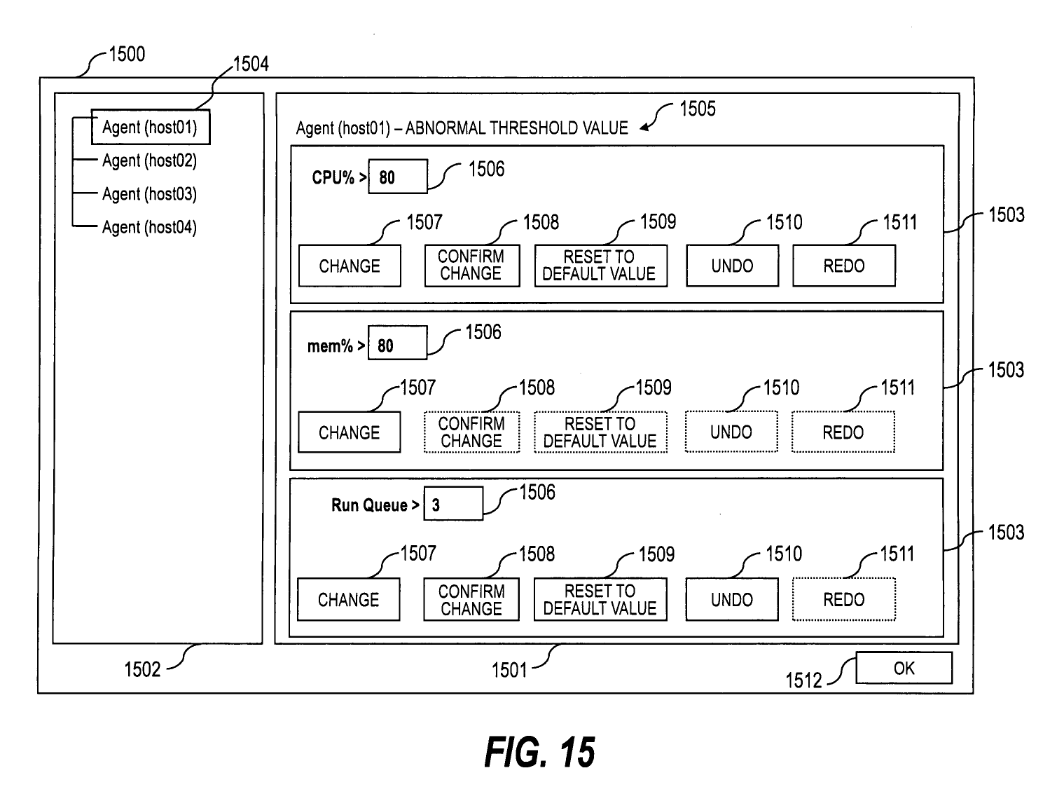

FIG. 15 illustrates an example of a monitoring screen referred to by the system administrator 10 according to the embodiment of this invention.

A monitoring screen 1500 shown in FIG. 15 includes an agent selection part 1502 and a threshold value input part 1501.

The agent selection part 1502 is a screen for selecting a performance monitoring agent 13 where an applied policy is changed. For example, the agent selection part 1502 enumerates performance monitoring agents 13 to be managed by the performance monitoring manager 12.

“Agent (host 01)” shown in FIG. 15 or the like is information for identifying each performance monitoring agent 13. When the system administrator 10 selects, for example, “Agent (host 01)” 1504 by input means such as a mouse, an alarm condition edit screen regarding a policy correlated with a performance monitoring agent 13 identified by the “Agent (host 01)” 1504 is displayed in the threshold value input part 1501.

The threshold value input part 1501 is a screen for displaying a list of policies applied to the performance monitoring agent 13 selected by the agent selection part 1502 to receive changes thereof.

The threshold value input part 1501 includes at least one policy changing part 1503. Specifically, the threshold value input part 1501 includes policy changing parts 1503 corresponding to policies applied to the performance monitoring agent selected by the agent selection part 1502. Each policy changing part 1503 includes an alarm condition display part 1506 set in a policy and an operation menu for operating the policy.

The alarm condition display part 1506 includes a text box where alarm conditions of the policies applied to the performance monitoring agent 13 selected by the agent selection part 1502 are displayed and a threshold value is entered. It should be noted that means for entering the threshold value is not limited to the text box. For example, the alarm condition display part 1506 may include input means such as a select box.

The operation menu for operating the policy includes, for example, a change button 1507, a change confirm button 1508, a default value button 1509, an UNDO button 1510, and a REDO button 1511. However, the operation menu is not limited to the buttons. For example, the operation menu may be a text link, and any method for realizing other similar functions upon selection by the input means such as a mouse may be used. Alternatively, not upon selection or entry by the input means such as a mouse, but upon issue of a processing event, similar functions may be executed. Each policy changing part 1503 may include only a part of the operation menu.

The change button 1507 has a function of issuing a policy change request upon operation of the input means such as a mouse. When the system administrator 10 enters a new threshold value in the text box of the alarm condition display part 1506 to select the change button 1507, a policy change request for generating an investigation policy where an alarm conditional expression including the new threshold value is set is issued. The change button 1507 can always be selected irrespective of whether an investigation policy has been generated.

The change confirm button 1508 has a function of issuing a policy change confirmation message. When the system administrator 10 selects the change confirm button 1508, a process of reflecting contents of the investigation policy displayed in the alarm condition display part 1506 in a production-environment policy is carried out. The change confirm button 1508 cannot be selected unless an investigation policy has been generated.

The default value button 1509 has a function of issuing a policy change discard message. When the system administrator 10 selects the default value button 1509, a process of rewriting contents of an investigation policy displayed in the alarm condition display part 1506 with contents of a production-environment policy is carried out. The default value button 1509 cannot be selected unless an investigation policy has been generated.

The UNDO button 1510 has a function of returning contents of a currently investigated investigation policy to those of an investigation policy before a change or a production-environment policy. When the system administrator 10 selects the UNDO button 1510, a process of referring to policy change history by tracing to return contents of the policy to those of the past policy. The UNDO button 1510 cannot be selected if no policy change history information has been accumulated or there is no change history information to return to.

The REDO button 1511 has a function of canceling selection of the UNDO button. In other words, the REDO button 1511 has a function of conversely advancing to a status before pressing the UNDO button when contents of a policy are returned to those before a change by selecting the UNDO button. The REDO button 1511 cannot be selected if no policy change history information has been accumulated or there is no change history information to advance to.

It should be noted that the monitoring screen shown in FIG. 15 is only an example and that the monitoring screen of this embodiment is not limited to the shown screen. For example, in the alarm condition display part 1506, when a change is added to the contents of the production-environment policy, the alarm condition display part 1506 may be displayed with emphasis. Alternatively, when a policy change request message is transmitted, a policy before the transmission of the change request message may be specified by referring to the policy change table 240, and the contents of the before-change policy may be compared with those of the after-change policy to display a difference in the monitoring screen 1500 with emphasis. For example, when there is a difference in threshold value between alarm conditions, the system administrator 10 can be notified of a change of the threshold value by displaying the alarm condition display section 1506 with emphasis by a thick character or a color.

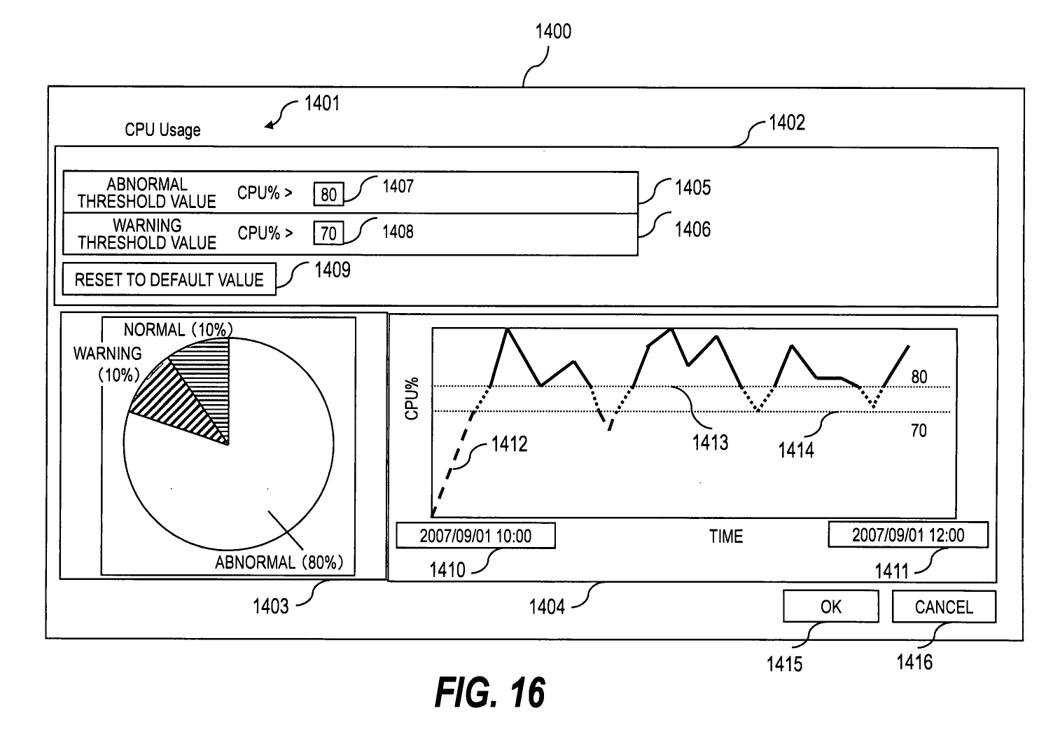

FIG. 16 illustrates an example of a monitoring screen displayed to adjust a threshold value of a conditional expression set in a policy according to the embodiment of this invention.

For example, this screen is used when a certain performance monitoring agent 13 is specified to perform change investigation for a first policy which is a policy for monitoring a production environment. In other words, this screen is a monitoring screen used for referring to pieces of history information collected and accumulated by the specified performance monitoring agent 13 to judge whether a threshold value set in the first policy is proper, and adjusting the threshold value to be the most proper.

A monitoring screen 1400 shown in FIG. 16 includes a policy name display part 1401, a threshold value input part 1402, a history information display part 1404, and an alarm monitoring result display part 1403.

The policy name display part 1401 displays a name of a policy whose threshold value is to be adjusted.

The threshold value input part 1402 receives an entry for adjusting the threshold value set in the conditional expression of the policy.

The threshold value input part 1402 includes an abnormal threshold value input section 1405 and a warning threshold value input section 1406. The abnormal threshold value input section 1405 displays an alarm conditional expression for issuing an abnormal event and includes an abnormal threshold value input section 1407. The warning threshold value input part 1406 displays an alarm conditional expression for issuing a warning event and includes a warning threshold value input section 1408.

For example, each of the abnormal threshold value input section 1407 and the warning threshold value input section 1408 may include a text box for editing the threshold value of the alarm conditional expression. When the system administrator 10 enters a changed threshold value in the text box, and selects a set button 1415 by input means such as a mouse, alarm-monitoring based on the entered threshold value is started. On the other hand, when the system administrator 10 selects a cancel button 1416, a changing process entered to the threshold value input part 1402 is discarded to finish the changing process of the first policy.

The threshold input means of the threshold value input part 1402 is not limited to the text box. A dialog box, or a pull-down or list type select box may be used.

The threshold value may be adjusted by dragging an abnormal threshold value 1413 or a warning threshold value 1414 displayed in the history information display part 1404 described below via input means such as a mouse. In this case, the threshold value adjusted by dragging is reflected to be displayed in the abnormal threshold value input section 1407 or the warning threshold value input section 1408.

When the system administrator 10 changes the abnormal threshold value input section 1407 or the warning threshold value input section 1408 to select a redraw button 1417 by input means such as a mouse, the contents of the history information display part 1404 and the alarm monitoring result display section 1403 are updated to start redrawing. The timing of starting redrawing of the history information display part 1404 and the alarm monitoring result display part 1403 is not limited to selection of the redraw box 1417. Redrawing may be started upon changing of input data of the abnormal threshold value input section 1407 or the warning threshold value input section 1408.

When the system administrator 10 selects a button 1409 to reset to a default value by input means such as a mouse, the value entered in the abnormal threshold value input part 1405 or the warning threshold value input part 1406 is reset to the abnormal threshold value or the warning threshold value of the first policy set as a production-environment policy.

The history information display part 1404 displays, among pieces of history information of performance information collected by the performance monitoring agent 13, history information of designated time and a threshold value set in a currently investigated policy in one and the same graph. This graph is referred to in order to investigate whether the threshold value set in the alarm conditional expression is valid. For example, the history information display part 1404 includes history information 1412, an abnormal threshold value 1413, a warning threshold value 1414, a display start time input section 1410, and a display end time input section 1411.

The history information 1412 indicates pieces of history information of performance information collected by the performance monitoring agent 13 during a period from the time of an entry to the display start time input section 1410 to the time of an entry to the display end time input section 1411 described below. The displayed performance information is a performance monitoring metric targeted by the abnormal threshold value 1413 or the warning threshold value 1414 regarding a policy to be changed. In the example of FIG. 16, CPU usages (%) are collected and displayed as pieces of performance information.

The abnormal threshold value 1413 displays a value entered to the abnormal threshold value input section 1405 in the graph of the history information display part 1404.

The warning threshold value 1414 displays a value entered to the warning threshold input unit 1406 in the graph of the history information display part 1404.

The display start time input section 1410 is for entering start time of the history information 1412 displayed in the graph of the history information display part 1404. For example, a date and time are entered by selecting a data select link displayed in the text box or a calendar.

The display end time input section 1411 is for entering end time of the history information 1412 displayed in the graph of the history information display part 1404. For example, a date and time are entered by selecting a date select link displayed in the text box or a calendar.

For example, whether a set threshold value is proper can be judged by designating a time zone when an abnormality occurs in the monitoring target 16 in the display start time input section 1410 and the display end time input section 1411.

The alarm monitoring result display part 1403 displays a result of comparing history information of the time zone indicated by the time entered to the display start time input section 1410 and the display end time input section 1411 of the history information display part 1404 with the threshold value entered to the threshold value input part 1402. Specifically, the alarm monitoring result display part 1403 displays, in the entire time of the history information, a ratio of time of an abnormal status (time when the value of the history information exceeds the abnormal threshold value, a ratio of time of a warning status (time when the value of the history information is larger than the warning threshold value but equal or less than the abnormal threshold value), and a ratio of time of a normal status (time when the value of the history information is equal to or less than the warming threshold value). The alarm monitoring result display part 1403 is referred to in order to judge whether the threshold value entered to the threshold value input part 1402 is valid. For example, the system administrator 10 designates history information of a time zone where a failure occurs in the monitoring target 16 by the history information display part 1404 to judge whether the ratio of time of the abnormal status or the warning status is sufficiently high in the time zone. Accordingly, whether the threshold value entered to the threshold value input part 1402 is valid (the value is not too high or too low) can be judged.

Thus, by referring to the monitoring screen 1400, a threshold value of an alarm condition for issuing an event at proper timing can be set. As a result, overlooking which happens even if a failure occurs or mistaken judgment of a failure which happens even if no failure occurs, which result from the invalid threshold value, can be prevented.

It should be noted that the data displayed in the history information display part 1404 is not limited to history information of a failure case or history information of a normal case and It should be noted that test information of a failure case or test information of a normal case may be displayed. In other words, not the pieces of history information collected by the performance monitoring agent 13 but performance information data indicating a failure of a monitoring target which requires issue of an abnormal event or a warning event may be fetched from the outside to be displayed in the history information display part 1404. Similarly, normal performance information data which inhibits issue of an abnormal event or a warning event may be fetched from the outside to be displayed in the history information display part 1404.

It should be noted that according to the embodiment of this invention, policy change history may be stored in the policy change table. Accordingly, even after reception of the policy change confirmation message, the system administrator can refer to changed contents of the policy investigated in the past based on the change history, and return the contents of the current policy to those of the policy investigated in the past. When the number of policy changing times is plural, the system administrator can return the contents to those of a policy several times before.

According to the embodiment, the policy setting management unit 19 may store correlation information between pieces of policy change information in the storage unit 20. Thus, changing and investigation of a plurality of policies, reflection of changes on the plurality of policies, and discarding of changes of the plurality of policies can be executed en bloc.

Further, by prestoring information regarding a group to which a policy belongs (policy group), changing and investigation, change confirmation, and discarding of changes can be executed en bloc for each policy group.

A process for each policy group will be described below.

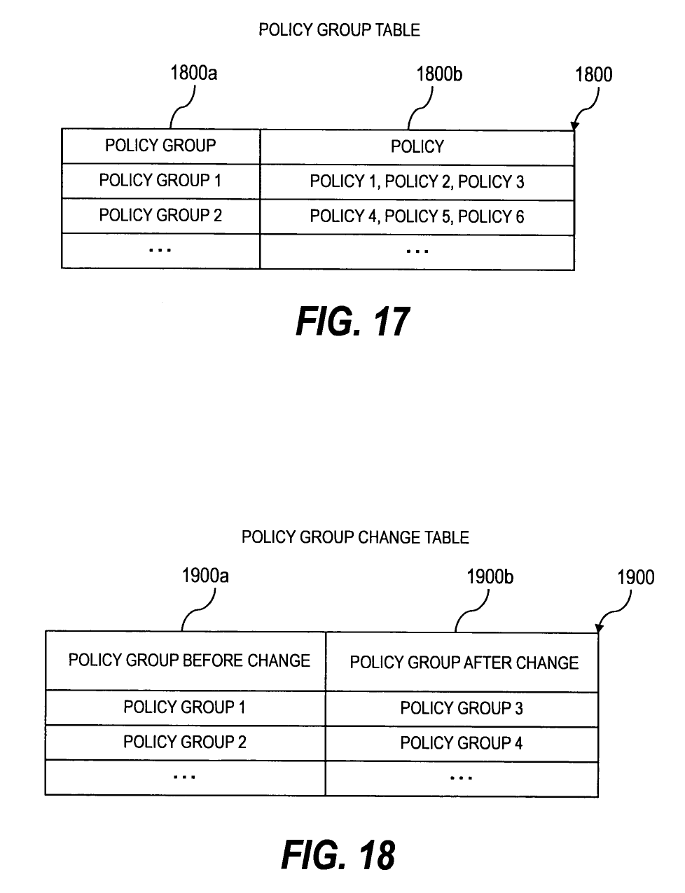

FIG. 17 illustrates a policy group table 1800 according to the embodiment of this invention.

The policy group table 1800 of this embodiment may be stored, for example, in the storage unit 20 of the performance monitoring manager 12.

As shown in FIG. 17, the policy group table 1800 includes a policy group ID section 1800a and a policy ID section 1800b.

In the policy group ID section 1800a, identification information for uniquely identifying a policy group (e.g., a policy group name such as “POLICY GROUP 1”) is stored.

In the policy ID section 1800b, identification information for uniquely identifying a policy included in each policy group is stored. This identification information corresponds to a content stored in the policy ID section 250a of the policy management table 250.

In the example of FIG. 17, “POLICY GROUP 1” and “POLICY 1, POLICY 2, AND POLICY 3” are respectively stored in the policy group ID section 1800a and the policy ID section 1800b of a first record of the policy group table 1800. This indicates that a policy group identified by “POLICY GROUP 1” includes three policies identified by “POLICY 1”, “POLICY 2”, and “POLICY 3”.

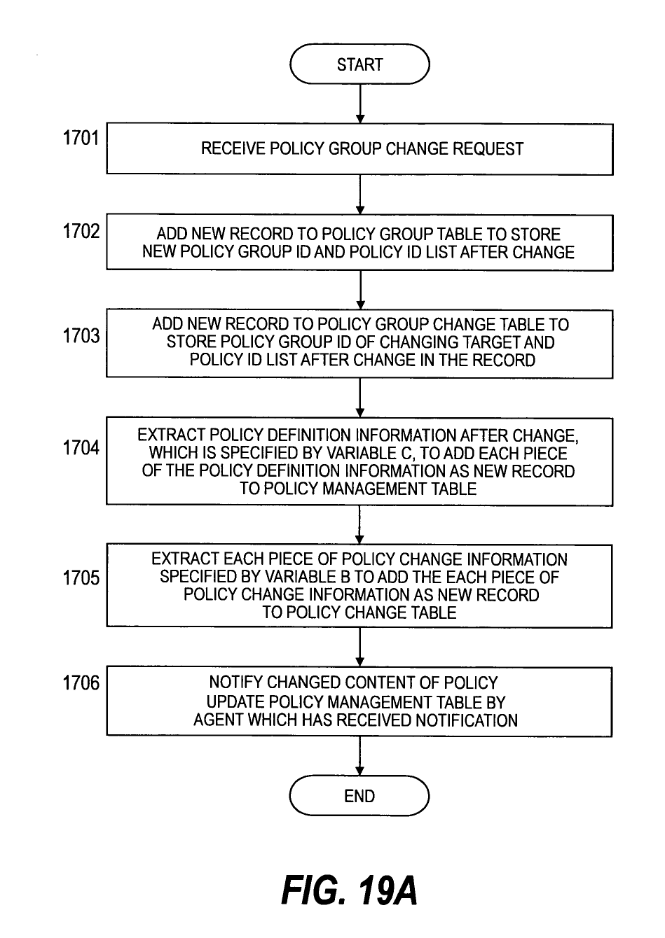

FIG. 18 illustrates a policy group change table 1900 according to the embodiment of this invention.

The policy group change table 1900 of this embodiment may be stored, for example, in the storage unit 20 of the performance monitoring manager 12.

As shown in FIG. 18, the policy group change table 1900 includes a before-change policy group ID section 1900a and an after-change policy group ID section 1900b. Each record of the policy group change table 1900 stores changing of a policy group corresponding to a content stored in the before-change policy group ID section 1900a to a policy group corresponding to a content stored in the after-change policy group ID section 1900b.

In each of the before-change policy group ID section 1900a and the after-change policy group ID section 1900b, identification information for uniquely identifying a policy group is stored. The identification information corresponds to the content stored in the policy group ID section 1800a of the policy group table 1800.

In the example of FIG. 18, “POLICY GROUP 1” and “POLICY GROUP 2” are respectively stored in the before-change policy group ID section 1900a and the after-change policy group ID section 1900b of the first record of the policy group change table 1900. This indicates that a policy group (e.g., first policy group) identified by “POLICY GROUP 1” and a policy group (e.g., second policy group) identified by “POLICY GROUP 2” are correlated with each other. The correlation between the first and second policy groups may mean, for example, that policies included in the first policy group are production-environment policies and policies included in the second policy group are investigation policies derived from the policies included in the first policy group.

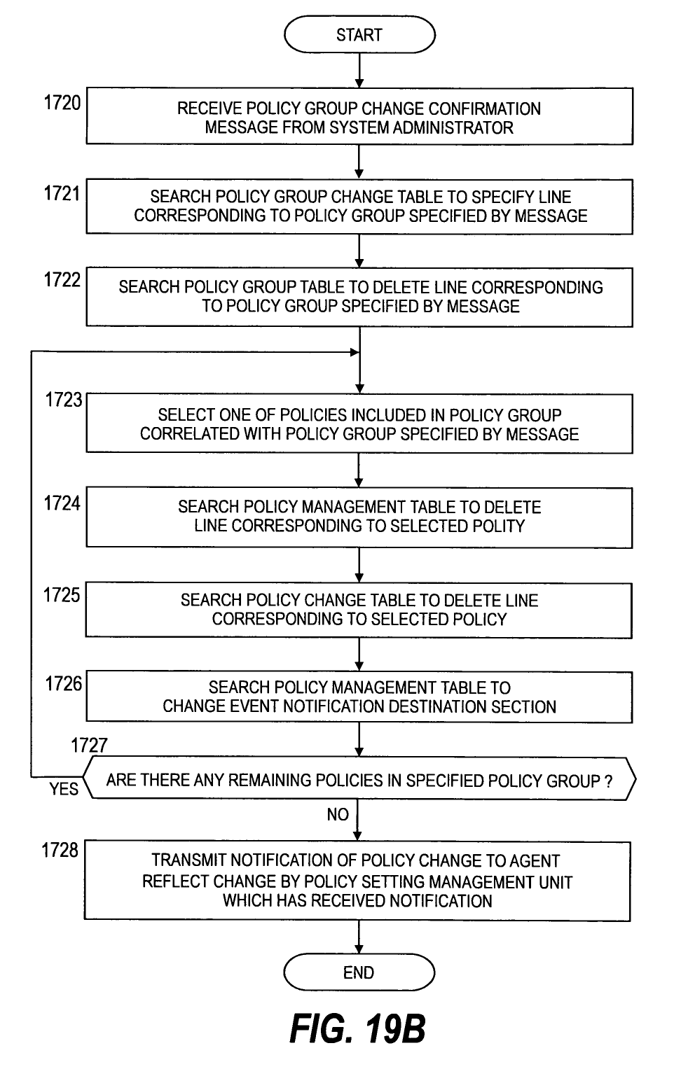

FIG. 19A is a flowchart illustrating a process executed when a policy change request message is issued for each policy group according to the embodiment of this invention.

The policy setting management unit 19 receives a policy group change request. A policy group change request message includes a variable A for specifying a policy group ID to identify a policy group of a changing target. Further, the policy group change request message specifies a list of pieces of change information of each policy belonging to the policy group of the variable A as a variable B, and policy definition information after a change as a variable C (Step 1701).

Next, the policy setting management unit 19 adds a new record to the policy group table 1800 to store the record as a variable D. The policy setting management unit 19 generates a policy group ID, and stores the generated policy group ID as a variable D1 in the policy group ID section 1800a of the variable D. The policy setting management unit 19 also stores a policy ID list after the change based on the policy change information specified by the variable B in the policy section of the variable D (Step 1702).

Next, the policy setting management unit 19 adds a new record to the policy group change table 1900 to store the record as a variable E. The policy setting management table 19 substitutes the variable A for the before-change policy group ID section 1900a of the variable E, and the variable D1 for the after-change policy group ID section 1900b (Step 1703).

Next, the policy setting management unit 19 extracts each piece of after-change policy definition information specified by the variable C to add it as a new record to the policy management table 250 (Step 1704).

Next, the policy setting management unit 19 extracts each piece of policy change information specified by the variable B to add it as a new record to the policy change table 240 (Step 1705).

Next, the policy setting management unit 19 notifies the performance monitoring agent 13 of policy changed contents. The performance monitoring agent 13 that has received the notification updates the policy management table 310 (Step 1706).

In Step 1701, the system administrator 10 may present a list of policies belonging to a policy group to instruct changing. However, when the system administrator 10 transmits a policy change request message for a certain policy, the policy setting management unit 19 may refer to the policy group table 1800 to obtain a list of policies correlated with the policy, and instruct the system administrator 10 to change the list of correlated policies.

FIG. 19B is a flowchart illustrating a process executed when a policy change confirmation message of each policy group is issued according to the embodiment of this invention.

The system administrator may transmit a policy change confirmation message for a plurality of policies. A process where a plurality of policies are controlled as a policy group, and the system administrator transmits a change confirmation message of the policy group for the policy group, thereby confirming changing process of policies belonging to the policy group en bloc will be described.

Next, the policy setting management unit 19 receives the policy group change confirmation message transmitted from the system administrator 10. The policy setting management unit 19 stores a policy group specified by the policy group change confirmation message as a variable D (Step 1720).

Next, the policy setting management unit 19 searches the policy group change table 1900 to store a record where a content of the before-change policy group ID section 1900a matches the variable D as a variable E. The policy setting management unit 19 stores a content of the after-change policy group ID section 1900b of the variable E as a variable F (Step 1721).

Next, the policy setting management unit 19 searches the policy group table 1800 to store a record where a content of a policy group ID section 1800a matches the variable F as a variable G. The policy setting management unit 19 stores a policy ID section 1800b of the variable G as a variable H. The policy setting management unit 19 deletes the record of the variable G from the policy group table 1800 (Step 1722).

Next, the policy setting management unit 19 selects one of the elements of the variable H, and stores the selected element as a variable H1 (Step 1723).

Next, the policy setting management unit 19 searches the policy management table 250 to store a record where a content of the policy ID section 250a matches the variable H1 as a variable I. The policy setting management unit 19 stores a content of the event notification destination section 250e of the variable I as a variable I1. The policy setting management unit 19 deletes the record of the variable I from the policy management table 250 (Step 1724).

Next, the policy setting management unit 19 searches the policy change table 240 to store a record where a content of the before-change policy ID section 240a matches the variable H1 as a variable J. The policy setting management unit 19 stores the after-change policy ID section 240b of the variable J as a variable K. The policy setting management unit 19 deletes the record of the variable J (Step 1725).

Next, the policy setting management unit 19 searches the policy management table 250 to store a record where a content of the policy ID section 250a matches the variable K as a variable L. The variable I1 is substituted for the event notification destination section 250e of the variable L (Step 1726).

The policy setting management unit 19 judges whether there is a remaining element in the variable H. If a result of the judgment shows that there is a remaining element, the process returns to Step 1723. If there is no remaining element, the process proceeds to Step 1728 (Step 1727).

Next, the policy setting management unit 19 transmits a notification of instructing a policy change to the performance monitoring agent 13. The policy setting management unit 28 that has received the notification searches the policy management table to reflect the change (Step 1728).

Through the process described above, a plurality of correlated polices can be change-confirmed en bloc. Thus, policy change confirmation omission can be prevented.

Any method may be employed to carry out a process of reflecting a change in a policy. For example, it is presumed that to investigate a first policy group for a production environment, the first policy group is copied to generate a second policy table, and to perform investigation. It is also presumed that the first policy group includes first and second policies and that a second policy group includes third and fourth policies respectively generated from the first and second policies. In this case, a reflection process may be executed by, for example, deleting the first and second policies as described above and changing the third and fourth policies to production-environment policies. Alternatively, for example, defined contents of the first and second policies may be overwritten with information other than an event notification destination among pieces of policy definition information of the third and fourth policies, and the third and fourth policies may be deleted.

According to this embodiment described above, the event notification destination is changed to reflect the investigation policy in the production-environment policy. However, this reflection may be executed by another method. It should be noted that for this policy reflection operation, the process of deleting the old production-environment policy after the reflection is not always necessary. The old production-environment policy may be stored as policy change history.

According to this embodiment, the policy setting management unit 19 that has received the policy change request message stores the policy change information in the policy change table 240. However, when a new policy group change table 1900 is newly provided in the storage unit 20 to store change information between policy groups, and a policy change request message of the policy group is received, policy groups before and after the change may be stored as change information in the policy group change table 1900. In this case, upon reception of a policy change confirmation message, the policy setting management unit 19 searches the policy group change table 1900, and refers to the original policy group to carry out a reflection process.

A plurality of policy groups may be added to a policy like tags. In other words, one policy may be included in a plurality of policy groups.

It should be noted that according to this embodiment, the performance monitoring manager host 40, the performance monitoring agent host 41, and the monitoring terminals A 43a and B 43b are described as separate devices. However, this invention is not limited to this configuration. In other words, each unit may include one device (one computer or one terminal).

According to the embodiment described above, one performing monitoring manager 12 manages one or a plurality of performance monitoring agents 13. However, this invention is not limited to this configuration. For example, the information processing system realizing this invention may include a performance monitoring submanager (not shown) for managing one or a plurality of performance monitoring agents 13, and may further include a performance monitoring manager for managing one or a plurality of performance monitoring submanagers. This configuration is particularly effective when a great many performance monitoring agents 13 have to be managed by a large system. Alternatively, for example, two performance monitoring managers 12 may be operated in different performance monitoring manager hosts 40 with one performance monitoring manager 12 operating as a main system (active system) and the other performance monitoring manager operating as a standby system (spare system).

Further, according to the embodiment described above, one performance monitoring agent 13 monitors one monitoring target 16. However, this invention is not limited to this configuration. In other words, one performance monitoring agent 13 may monitor one or a plurality of monitoring targets 16. Alternatively, two or more performance monitoring agents 13 may monitor one monitoring target 16. For example, in the configuration where two performance monitoring agents 13 monitor one monitoring target 16, performance monitoring agents 13 may be operated as a main system (active system), and the other may be operated as a standby system (spare system).

According to this embodiment, the monitoring console 14 and the integration console 15 are described as different components. However, this invention is not limited to this configuration. In other words, the monitoring console 14 and the integration console 15 may be configured as one component, and contents to be displayed may be selected according to operator's authority. For example, a console having both functions of the monitoring and integration consoles 14 and 15 may be configured. In the case of logging-in the console by a password of operator's authority, contents for the operator may be displayed in the console. In the case of logging-in by a password of system administrator's authority, contents for the system administrator may be displayed in the console. Further, according to this embodiment, only one monitoring console 14 and only one integration console 15 have been described. However, this invention is not limited to this configuration. In other words, one or a plurality of monitoring terminals may be configured as monitoring consoles 14 or integration consoles, and a plurality of system administrators and a plurality of operators may perform monitoring.

According to the embodiment described above, the performance monitoring manager 40, the performance agent host 41, and the monitoring terminals A 43a and B 43b can communicate with one another via the network 49. However, this invention is not limited to this configuration. In other words, some or all of the devices may be coupled via difference networks. For example, a local area network to which the performance monitoring manager host 40 and the performance monitoring agent host 41 belong, a local network to which the monitoring terminal A 43a belongs, and a local area network to which the monitoring terminal B 43b belongs may be configured as different networks. These local area networks may be coupled to communicate with one another via the Internet.

It should be noted that the network 49 may be realized by any communication method. For example, for the network 49, any one of communication methods based on wire or radio networks may be employed. The network 49 may also be a physical or logical network.

According to the embodiment described above, the event issue unit 17 notifies the integration console 15 and the monitoring console 14 of an event. However, this invention is not limited to this configuration. In other words, the event issue unit 26 may notify the integration console 15 and the monitoring console 14 of an event.

Further, FIG. 2 illustrates the example where the event is notified to the integration console 15 and the monitoring console 14. However, this invention is not limited to this configuration. In other words, the event issue unit 17 may distribute mail to the operator 11 or the system administrator 10, or ask a designated command execution host to execute a command.

Further, the embodiment has been described by way of the case where each component (e.g., policy setting management unit 19) of the information processing system is software (in other words, program executed in the computer). However, this does not mean that this embodiment cannot be realized unless the component is mounted as software. For example, even if some or all of the policy setting management unit 19, the policy setting distribution unit 18, the storage unit 20, the transmission/reception unit 44, and the event issue unit 17 of the performance monitoring manager 12, the event issue unit 26, the alarm judgment unit 27, the policy setting management unit 28, and the collection unit 29 of the performance monitoring agent 13 are mounted as hardware pieces, this embodiment can be realized.

While the present invention has been described in detail and pictorially in the accompanying drawings, the present invention is not limited to such detail but covers various obvious modifications and equivalent arrangements, which fall within the purview of the appended claims.

What is claimed is:

1. A method of controlling a computer system including at least one computer,
each of the at least one computer including an interface coupled to a network, a processor coupled to the interface, and a memory coupled to the processor,
the computer system including an agent realized by executing a predetermined program by at least one processor, and a management unit realized by executing a predetermined program by at least one processor,
the computer system holding a plurality of monitoring conditions used for monitoring a metric value of a resource included in the computer system,
the plurality of monitoring conditions including a first monitoring condition,
the method comprising:
a first step of transmitting, by the agent, a monitoring result of the metric value based on the first monitoring condition;
a second step of generating, by the management unit, upon reception of a first change request containing information for identifying the first monitoring condition and information for specifying contents to be changed with respect to the first monitoring condition, a second monitoring condition which is one of the plurality of monitoring conditions based on the contents to be changed contained in the first change request;
a third step of transmitting, by the management unit, an addition request for adding the second monitoring condition to the agent;
a fourth step of transmitting, by the agent which has received the addition request, a monitoring result of the metric value based on the second monitoring condition;
a fifth step of holding, by the management unit, first information for correlating the first monitoring condition and the second monitoring condition with each other;
a sixth step of specifying, by the management unit, upon reception of a confirmation request for confirming the second monitoring condition, the first monitoring condition correlated with the second monitoring condition based on the first information;
a seventh step of transmitting, by the management unit, a deletion request for deleting the first monitoring condition to the agent; and
an eighth step of stopping, by the agent which has received the deletion request, the transmitting of the monitoring result of the metric value based on the first monitoring condition.

2. The method according to claim 1, wherein:
the first step includes transmitting, by the agent, the monitoring result of the metric value based on the first monitoring condition to a first transmission destination;
the fourth step before reception of the deletion request after reception of the addition request includes transmitting, by the agent, the monitoring result of the metric value based on the second monitoring condition to a second transmission destination instead of the first transmission destination; and
the eighth step after reception of the deletion request includes transmitting, by the agent, the monitoring result of the metric value based on the second monitoring condition to the first transmission destination.

3. The method according to claim 1, wherein:
the computer system includes a plurality of the agents;
the first step includes transmitting, by each of the plurality of the agents, a monitoring result of a metric value of one of a plurality of the resources included in the computer system based on the first monitoring condition;
the method further comprises:
a ninth step of holding, by the management unit, second information for correlating the first monitoring condition with the plurality of the agents each transmitting the monitoring result of the metric value based on the first monitoring condition; and
a tenth step of specifying, by the management unit, based on the second information, the plurality of the agents each transmitting the monitoring result of the metric value based on the first monitoring condition; and
the seventh step includes transmitting, by the management unit, the deletion request to the plurality of the specified agents.

4. The method according to claim 1, further comprising:
an eleventh step of generating, by the management unit, before reception of the confirmation request after reception of the first change request, upon reception of a second change request containing information for identifying the second monitoring condition and information for specifying contents to be changed with respect to the second monitoring condition, based on the second change request, a third monitoring condition which is one of the plurality of monitoring conditions;
a twelfth step of transmitting, by the management unit, an addition request for adding the third monitoring condition to the agent; and
a thirteenth step of transmitting, by the agent which has received the addition request, a monitoring result of the metric value based on the third monitoring condition, wherein:
the first information contains information for correlating the second monitoring condition and the third monitoring condition with each other;
the sixth step includes:
specifying, by the management unit, upon reception of a confirmation request for confirming the third monitoring condition, based on the first information, the second monitoring condition correlated with the third monitoring condition; and
specifying, by the management unit, based on the first information, the first monitoring condition correlated with the second monitoring condition;
the seventh step includes transmitting, by the management unit, a deletion request for deleting the first monitoring condition and the second monitoring condition to the agent; and
the eighth step includes stopping, by the agent which has received the deletion request, the transmitting of the monitoring result of the metric value based on the first monitoring condition and the transmitting of the monitoring result of the metric value based on the second monitoring condition.

5. The method according to claim 1, further comprising:
a fourteenth step of generating, by the management unit, before reception of the confirmation request after reception of the first change request, upon reception of a second change request containing information for identifying the first monitoring condition and information for specifying contents to be changed with respect to the first monitoring condition, based on the second change request, a third monitoring condition which is one of the plurality of monitoring conditions;
a fifteenth step of transmitting, by the management unit, an addition request for adding the third monitoring condition to the agent; and
a sixteenth step of transmitting, by the agent which has received the addition request, a monitoring result of the metric value based on the third monitoring condition, wherein:
the first information contains information for correlating the first monitoring condition and the third monitoring condition with each other;
the sixth step includes:
specifying, by the management unit, upon reception of a confirmation request for confirming the third monitoring condition, based on the first information, the first monitoring condition correlated with the third monitoring condition; and
specifying, by the management unit, based on the first information, the second monitoring condition correlated with the first monitoring condition;
the seventh step includes transmitting, by the management unit, a deletion request for deleting the first monitoring condition and the second monitoring condition to the agent; and
the eighth step includes stopping, by the agent which has received the deletion request, the transmitting of the monitoring result of the metric value based on the first monitoring condition and the transmitting of the monitoring result of the metric value based on the second monitoring condition.

6. The method according to claim 1, further comprising a seventeenth step of transmitting, by the management unit, before reception of the confirmation request for confirming the second monitoring condition, upon reception of a discard request for discarding the second monitoring condition, a deletion request for deleting the second monitoring condition to the agent,
wherein the eighth step includes stopping, by the agent which has received the deletion request based on the seventeenth step, the transmitting of the monitoring result of the metric value based on the second monitoring condition.

7. The method according to claim 1, wherein:
the plurality of monitoring conditions further includes a fourth monitoring condition, a fifth monitoring condition, a sixth monitoring condition, and a seventh monitoring condition;
the computer system is configured to:
hold third information containing information for correlating a first monitoring condition group with the fourth monitoring condition and the fifth monitoring condition included in the first monitoring condition group, and information for correlating a second monitoring condition group with the sixth monitoring condition and the seventh monitoring condition included in the second monitoring condition group; and
include a plurality of the agents which include a first agent and a second agent; and
the method further comprises:
an eighteenth step of specifying, by the management unit, upon reception of a third change request containing information for specifying the first monitoring condition group and information for specifying contents to be changed with respect to the first monitoring condition group, based on the third information, the fourth monitoring condition and the fifth monitoring condition included in the first monitoring condition group;
a nineteenth step of generating, by the management unit, based on the contents to be changed contained in the third change request, the sixth monitoring condition and the seventh monitoring condition;
a twentieth step of transmitting, by the management unit, an addition request for adding the sixth monitoring condition and an addition request for adding the seventh monitoring condition to the first agent and the second agent, respectively;
a twenty-first step of transmitting, by the first agent, a monitoring result of the metric value based on the sixth monitoring condition;
a twenty-second step of transmitting, by the second agent, a monitoring result of the metric value based on the seventh monitoring condition;
a twenty-third step of holding, by the management unit, fourth information for correlating the first monitoring condition group with the second monitoring condition group;
a twenty-fourth step of specifying, by the management unit, upon reception of a confirmation request for confirming the second monitoring condition group, based on the fourth information, the first monitoring condition group correlated with the second monitoring condition group;
a twenty-fifth step of specifying, by the management unit, based on the third information, the fourth monitoring condition and the fifth monitoring condition included in the first monitoring condition group;
a twenty-sixth step of transmitting, by the management unit, a deletion request for deleting the fourth monitoring condition and a deletion request for deleting the fifth monitoring condition to the first agent and the second agent, respectively; and
a twenty-seventh step of stopping, by the first agent and the second agent which have received the deletion requests, transmission of monitoring results of the metric values based on the fourth monitoring condition and the fifth monitoring condition, respectively.

8. The method according to claim 1, wherein:
each of the monitoring conditions includes information for specifying the metric value of the resource to be monitored, and information for specifying a threshold value to be compared with the metric value; and
the monitoring result of the metric value based on the each of the monitoring conditions contains information indicating a result of comparison of the metric value specified by the each of the monitoring conditions with the threshold value specified by the each of the monitoring conditions.

9. A method of controlling a computer system including at least one computer,
each of the at least one computer including an interface coupled to a network, a processor coupled to the interface, and a memory coupled to the processor,
the computer system including an agent realized by executing a predetermined program by at least one processor, and a management unit realized by executing a predetermined program by at least one processor,
the method comprising:
a first step of transmitting, by the agent, a monitoring result of a metric value of a resource included in the computer system based on a first monitoring condition to a first transmission destination;
a second step of generating, by the management unit, upon reception of a first change request containing information for identifying the first monitoring condition and information for specifying contents to be changed with respect to the first monitoring condition, a second monitoring condition based on the contents to be changed contained in the first change request;
a third step of transmitting, by the management unit, an addition request for adding the second monitoring condition to the agent;
a fourth step of transmitting, by the agent which has received the addition request, a monitoring result of the metric value of the resource based on the second monitoring condition to a second transmission destination instead of the first transmission destination;
a fifth step of transmitting, by the management unit, a deletion request for deleting the first monitoring condition to the agent; and
a sixth step of stopping, by the agent which has received the deletion request, the transmitting of the monitoring result of the metric value of the resource based on the first monitoring condition, and transmitting the monitoring result of the metric value of the resource based on the second monitoring condition to the first transmission destination.

10. A computer system, comprising:
at least one computer including an interface coupled to a network, a processor coupled to the interface, and a memory coupled to the processor;
an agent realized by executing a predetermined program by at least one processor; and
a management unit realized by executing a predetermined program by at least one processor, wherein:
the computer system holds a plurality of monitoring conditions each used for monitoring a metric value of a resource included in the computer system;
the plurality of monitoring conditions include a first monitoring condition;
the agent transmits a monitoring result of the metric value based on the first monitoring condition;
the management unit is configured to:
generate, upon reception of a first change request containing information for identifying the first monitoring condition and information for specifying contents to be changed with respect to the first monitoring condition, a second monitoring condition which is one of the plurality of monitoring conditions based on the contents to be changed contained in the first change request; and
transmit an addition request for adding the second monitoring condition to the agent;
the agent which has received the addition request transmits a monitoring result of the metric value based on the second monitoring condition;
the computer system holds first information for correlating the first monitoring condition and the second monitoring condition with each other;
the management unit is configured to:
specify, upon reception of a confirmation request for confirming the second monitoring condition, the first monitoring condition correlated with the second monitoring condition based on the first information; and
transmit a deletion request for deleting the first monitoring condition to the agent; and
the agent which has received the deletion request stops the transmitting of the monitoring result of the metric value based on the first monitoring condition.

11. The computer system according to claim 10, wherein the agent is further configured to:
transmit the monitoring result of the metric value based on the first monitoring condition to a first transmission destination;
transmit, before reception of the deletion request after reception of the addition request, the monitoring result of the metric value based on the second monitoring condition to a second transmission destination instead of the first transmission destination; and
transmit, after reception of the deletion request, the monitoring result of the metric value based on the second monitoring condition to the first transmission destination.

12. The computer system according to claim 10, further comprising a plurality of the agents, wherein:
each of the plurality of the agents transmits a monitoring result of a metric value of one of a plurality of the resources included in the computer system based on the first monitoring condition;
the computer system holds second information for correlating the first monitoring condition with the plurality of the agents each transmitting the monitoring result of the metric value based on the first monitoring condition; and
the management unit is further configured to:
specify, based on the second information, the plurality of the agents each transmitting the monitoring result of the metric value based on the first monitoring condition; and
transmit the deletion request to the plurality of the specified agents.

13. The computer system according to claim 10, wherein:
the management unit is further configured to:
generate, before reception of the confirmation request after reception of the first change request, upon reception of a second change request containing information for identifying the second monitoring condition and information for specifying contents to be changed with respect to the second monitoring condition, based on the second change request, a third monitoring condition which is one of the plurality of monitoring conditions; and
transmit an addition request for adding the third monitoring condition to the agent;
the agent which has received the addition request transmits a monitoring result of the metric value based on the third monitoring condition;
the first information contains information for correlating the second monitoring condition and the third monitoring condition with each other;
the management unit is further configured to:
specify, upon reception of a confirmation request for confirming the third monitoring condition, based on the first information, the second monitoring condition correlated with the third monitoring condition;
specify, based on the first information, the first monitoring condition correlated with the second monitoring condition; and
transmit a deletion request for deleting the first monitoring condition and the second monitoring condition to the agent; and
the agent which has received the deletion request stops the transmitting of the monitoring result of the metric value based on the first monitoring condition and the transmitting of the monitoring result of the metric value based on the second monitoring condition.

14. The computer system according to claim 10, wherein:
the management unit is further configured to:
generate, before reception of the confirmation request after reception of the first change request, upon reception of a second change request containing information for identifying the first monitoring condition and information for specifying contents to be changed with respect to the first monitoring condition, based on the second change request, a third monitoring condition which is one of the plurality of monitoring conditions; and
transmit an addition request for adding the third monitoring condition to the agent;
the agent which has received the addition request transmits a monitoring result of the metric value based on the third monitoring condition;
the first information contains information for correlating the first monitoring condition and the third monitoring condition with each other;
the management unit is further configured to:
specify, upon reception of a confirmation request for confirming the third monitoring condition, based on the first information, the first monitoring condition correlated with the third monitoring condition;
specify, based on the first information, the second monitoring condition correlated with the first monitoring condition; and
transmit a deletion request for deleting the first monitoring condition and the second monitoring condition to the agent; and
the agent which has received the deletion request stops the transmitting of the monitoring result of the metric value based on the first monitoring condition and the transmitting of the monitoring result of the metric value based on the second monitoring condition.

15. The computer system according to claim 10, wherein:
the management unit transmits, before reception of the confirmation request for confirming the second monitoring condition, upon reception of a discard request for discarding the second monitoring condition, a deletion request for deleting the second monitoring condition to the agent; and
the agent which has received the deletion request stops the transmitting of the monitoring result of the metric value based on the second monitoring condition.

16. The computer system according to claim 10, wherein:
the plurality of monitoring conditions further includes a fourth monitoring condition, a fifth monitoring condition, a sixth monitoring condition, and a seventh monitoring condition;
the computer system is further configured to:
hold third information containing information for correlating a first monitoring condition group with the fourth monitoring condition and the fifth monitoring condition included in the first monitoring condition group, and information for correlating a second monitoring condition group with the sixth monitoring condition and the seventh monitoring condition included in the second monitoring condition group; and
include a plurality of the agents which include a first agent and a second agent;
the management unit is further configured to:
specify, upon reception of a third change request containing information for specifying the first monitoring condition group and information for specifying contents to be changed with respect to the first monitoring condition group, based on the third information, the fourth monitoring condition and the fifth monitoring condition included in the first monitoring condition group;
generate, based on the contents to be changed contained in the third change request, the sixth monitoring condition and the seventh monitoring condition; and
transmit an addition request for adding the sixth monitoring condition and an addition request for adding the seventh monitoring condition to the first agent and the second agent, respectively;
the first agent transmits a monitoring result of the metric value based on the sixth monitoring condition;
the second agent transmits a monitoring result of the metric value based on the seventh monitoring condition;
the computer system further holds fourth information for correlating the first monitoring condition group with the second monitoring condition group;
the management unit is further configured to:
specify, upon reception of a confirmation request for confirming the second monitoring condition group, based on the fourth monitoring condition information, the first monitoring condition group correlated with the second monitoring condition group;
specify, based on the third information, the fourth monitoring condition and the fifth monitoring condition included in the first monitoring condition group; and
transmit a deletion request for deleting the fourth monitoring condition and a deletion request for deleting the fifth monitoring condition to the first agent and the second agent, respectively; and
the first agent and the second agent which have received the deletion requests stop transmission of monitoring results of the metric values based on the fourth monitoring condition and the fifth monitoring condition, respectively.

17. The computer system according to claim 10, wherein:
each of the monitoring conditions includes information for specifying the metric value of the resource to be monitored, and information for specifying a threshold value to be compared with the metric value; and
the monitoring result of the metric value based on the each of the monitoring conditions contains information indicating a result of comparison of the metric value specified by the each of the monitoring conditions with the threshold value specified by the each of the monitoring conditions.
